(19) United States
(12) Patent Application Publication
(10) Pub. No.: US 2023/0255269 A1
(43) Pub. Date: Aug. 17, 2023

(54) AEROSOL-GENERATING DEVICE

(71) Applicant: KT&G CORPORATION, Daejeon (KR)

(72) Inventors: Jongsub LEE, Sungnam-si Gyeonggi-do (KR); Minkyu KIM, Seoul (KR); Jueon PARK, Seoul (KR); Byungsung CHO, Gwangmyung-si Gyeonggi-do (KR)

(73) Assignee: KT&G CORPORATION, Daejeon (KR)

(21) Appl. No.: 18/015,931

(22) PCT Filed: Mar. 10, 2022
(86) PCT No.: PCT/KR2022/003345

§ 371 Date: Jan. 12, 2023

(30) Foreign Application Priority Data
Mar. 17, 2021 (KR) 10-2021-0034750

(51) Int. Cl. A24F 40/60; F21V 33/00; A24F 40/10; A24F 40/20; A24F 40/30; A24F 40/42

(52) U.S. Cl. CPC A24F 40/60; F21V 33/0004; A24F 40/10; A24F 40/20; A24F 40/30; A24F 40/42

(57) ABSTRACT

An aerosol-generating device is disclosed. The aerosol-generating device of the present disclosure includes a body; a cartridge coupled to the body, wherein the cartridge comprises: a first container providing a storage space, a second container adjacent to the first container, a wick disposed to be in communication with the storage space, and a heater configured to heat the wick; and a light source disposed at the body so as to be adjacent to the cartridge and configured to provide light to the cartridge, wherein the first container includes a window formed to allow light provided by the light source to pass therethrough.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems. It is another object of the present disclosure to provide an aerosol-generating device enabling a user to check the state of the interior of a cartridge using a light source providing light.

It is still another object of the present disclosure to enable a user to visually check the state of the interior of the cartridge even in a dark environment.

It is still another object of the present disclosure to prevent deterioration of a liquid stored in the cartridge.

### Solution to Problem

In accordance with an aspect of the present disclosure for accomplishing the above and other objects, there is provided an aerosol-generating device including a body; a cartridge coupled to the body, wherein the cartridge comprises: a first container providing a storage space, a second container adjacent to the first container, a wick disposed to be in communication with the storage space, and a heater configured to heat the wick; and a light source disposed at the body so as to be adjacent to the cartridge and configured to provide light to the cartridge, wherein the first container includes a window formed to allow light provided by the light source to pass therethrough.

### ADVANTAGEOUS EFFECTS OF INVENTION

According to at least one of embodiments of the present disclosure, it is possible to check the state of the interior of a cartridge using a light source providing light.

According to at least one of embodiments of the present disclosure, it is possible to visually check the state of the interior of the cartridge even in a dark environment.

According to at least one of embodiments of the present disclosure, it is possible to prevent deterioration of a liquid stored in the cartridge.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features, and other advantages of the present disclosure will be more clearly understood from the following detailed description taken in conjunction with the accompanying drawings, in which:

FIGS. 1 to 34 are views showing examples of an aerosol-generating device according to embodiments of the present disclosure.

### BEST MODE FOR CARRYING OUT THE INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

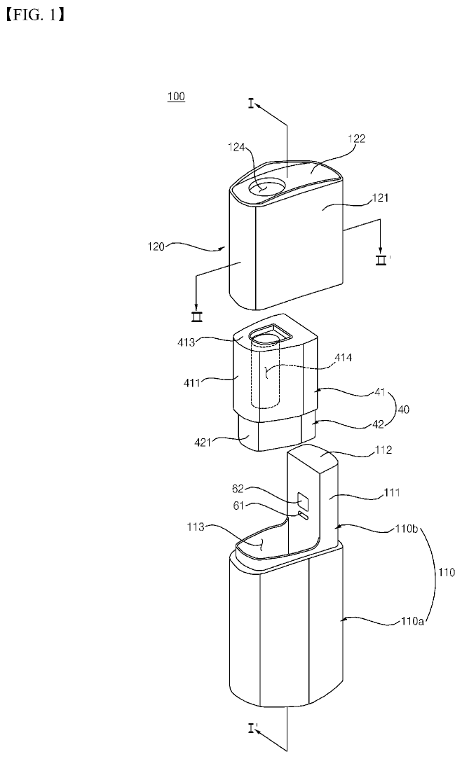

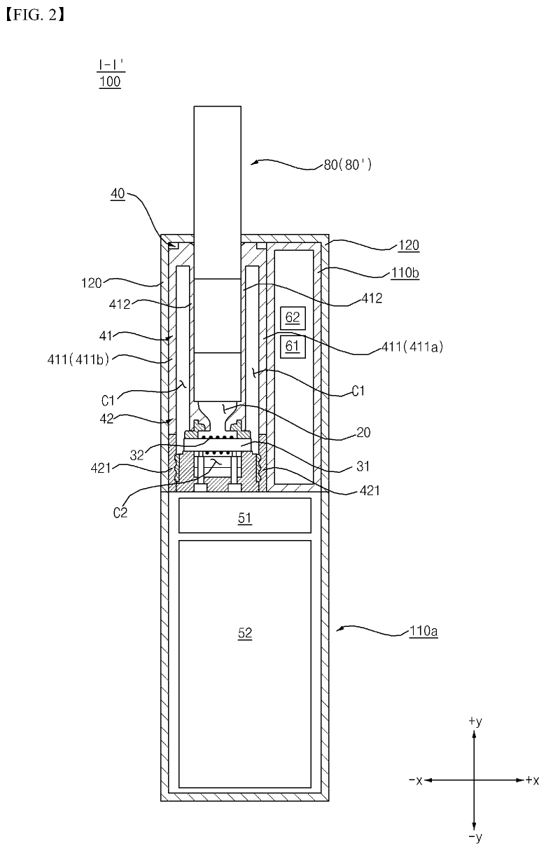

Referring to FIG. 1, an aerosol-generating device 100 may include a body 110 and a cartridge 40 coupled to one side of the body 110. The cartridge 40 may store a liquid therein. The cartridge 40 may include a first container 41 for storing a liquid and a second container 42 disposed under the first container 41. The first container 41 may provide an elongated insertion space 414. The insertion space 414 may be open upwards. A stick 80 or 80′ (refer to FIG. 2) may be inserted into the insertion space 414.

The body 110 may have a shape extending in an upward-downward direction. The body 110 may provide a space in which various components are disposed. The body 110 may include a lower body 110a and an upper body 110b disposed on the lower body 110a. The lower body 110a may have a shape extending in the upward-downward direction.

The lower body 110a may face the lower portion of the cartridge 40. The upper body 110b may have a shape extending upwards from the lower body 110a. The upper body 110b may be disposed parallel to the cartridge 40. The upper body 110b may face the side surface of the cartridge 40. The upper body 110b may face the side walls 411 and 421 of the cartridge 40.

The aerosol-generating device 100 may include a cap 120. The cap 120 may cover at least a portion of the body 110 and the cartridge 40. The cap 120 may be capable of being removed from the body 110. The cap 120 may be disposed on the lower body 110a, and may cover the upper body 110b. An opening 124 may be formed such that a portion of the upper wall 122 of the cap 120 is open. The opening 124 in the cap 120 may be formed at a position corresponding to the insertion space 414, and may communicate with the insertion space 414. The stick 80 or 80′ (refer to FIG. 2) may be inserted into the insertion space 414 through the opening 124.

A light source 61 may be disposed adjacent to the cartridge 40. The light source 61 may provide light to the cartridge 40. The light source 61 may face the cartridge 40. The light source 61 may be mounted inside the body 110. The light source 61 may be mounted in the upper body 110b.

The cartridge 40 may be provided in at least a portion thereof with a part through which the light provided from the light source 61 passes. In the cartridge 40, the part through which light passes may be referred to as a window. The cartridge 40 may include a window. The window may form at least a portion of the first container 41 and/or at least a portion of the second container 42. The cap 120 may include a portion that is made of a material that allows the light provided from the light source 61 to pass therethrough.

A sensor 62 may be disposed adjacent to the cartridge 40. The sensor 62 may be disposed outside the cartridge 40. The sensor 62 may be mounted on the upper body 110b. The sensor 62 may sense at least one of information about whether the stick 80 or 80′ is inserted into the insertion space 414, information about the stick 80 or 80′ inserted into the insertion space 414, or information about the amount of the liquid stored in the cartridge 40. The sensor 62 may include an infrared sensor or a color sensor. The infrared sensor or the color sensor may face a first chamber C1 (refer to FIG. 2). The infrared sensor or the color sensor may face the insertion space 414.

The sensor 62 may sense the flow of air. The sensor 62 may include a pressure sensor. The pressure sensor may be disposed adjacent to a path through which air flows.

Referring to FIG. 2, the cartridge 40 may include a first container 41 and a second container 42 disposed under the first container 41. The first container 41 may be elongated. The first container 41 may have a hollow shape.

The first container 41 may include an outer wall 411 and an inner wall 412. The outer wall 411 may extend in the upward-downward direction. The outer wall 411 may extend along the outer periphery of the first container 41.

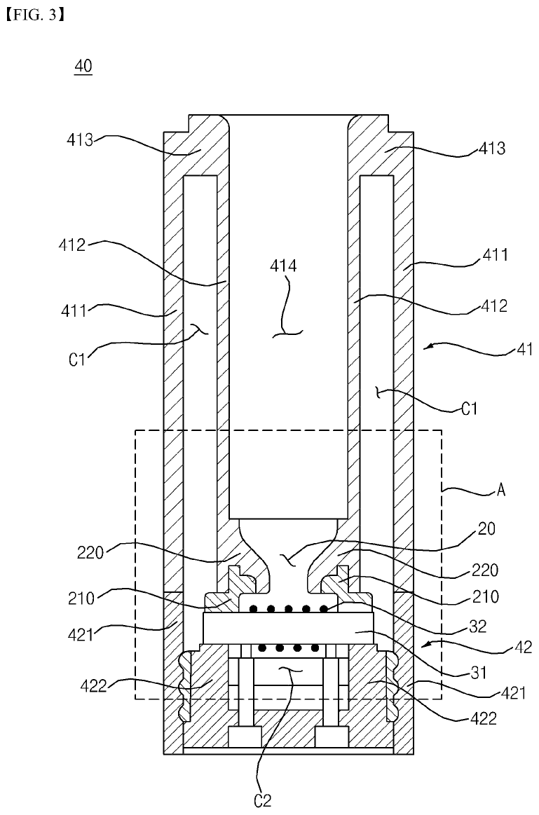

The inner wall 412 of the first container 41 may extend in the upward-downward direction. The inner wall 412 may extend along the inner periphery of the first container 41. The inner wall 412 may be spaced inwards apart from the outer wall 411. The upper side of the outer wall 411 and the upper side of the inner wall 412 may be connected to each other. The inner wall 412 may extend in a circumferential direction to form a cylindrical shape. The inner wall 412 may surround the insertion space 414 (refer to FIG. 3) to define the insertion space 414.

The outer wall 411 of the first container 41 may be referred to as an outer side wall 411 of the first container 41 or a side wall 411 of the first container 41. The inner wall 412 of the first container 41 may be referred to as an inner side wall 412.

The first container 41 may provide a first chamber C1 for storing a liquid therein. The first chamber C1 may be formed between the outer wall 411 and the inner wall 412 of the first container 41. The first chamber C1 may be referred to as a storage space.

A flow passage 20 may be formed in the lower portion of the inner wall 412 of the first container 41. The suctioned air may pass through the flow passage 20. The flow passage 20 may communicate with the insertion space 414 (refer to FIG. 3). The flow passage 20 may be disposed below the insertion space 414. The flow passage 20 may be formed between the insertion space 414 and a second chamber C2. The flow passage 20 may be formed between the insertion space 414 and a wick 31.

The second container 42 may provide a second chamber C2 therein. The second chamber C2 may be located below the flow passage 20. The second chamber C2 may communicate with the flow passage 20.

A wick 31 may be mounted in the second chamber C2 formed in the second container 42. The wick 31 may be connected to the interior of the first chamber C1. The wick 31 may receive a liquid from the first chamber C1. The wick 31 may be disposed adjacent to the lower end of the first chamber C1. The wick 31 may be disposed in the lower portion of the flow passage 20.

A heater 32 for heating the wick 31 may be provided. The heater 32 may be mounted in the second chamber C2. The heater 32 may be wound around the wick 31. The heater 32 may heat the wick 31, which receives the liquid, to generate an aerosol.

The air introduced into the second chamber C2 may sequentially pass through the flow passage 20 and the insertion space 414. The air introduced into the second chamber C2 may contain the aerosol generated from the wick 31. The aerosol generated from the wick 31 may be delivered to the stick 80 or 80′, which is inserted into the insertion space 414, through the flow passage 20.

Accordingly, the first chamber C1 of the first container 41, which provides the storage space therein, may be disposed so as to surround the stick 80 or 80′, and thus the efficiency of use of space for storing a liquid may be increased. Also, the distance from the wick 31 and the heater 32 to the insertion space 414, into which the stick 80 or 80′ is inserted, may be short, thus making it possible to increase the efficiency of transfer of the aerosol without substantial heat loss.

A controller 51 may be disposed inside the body 110. The controller 51 may control the on/off operation of the device. The controller 51 may be electrically connected to the heater 32 to control the supply of power to the heater 32 so that the heater 32 heats the wick. The controller 51 may be disposed adjacent to the heater 32.

The battery 52 may be disposed inside the body 110. The battery 52 may supply power to various components of the aerosol-generating device 100. The battery 52 may be electrically connected to the controller 51. The battery 52 may be disposed inside the lower body 110a.

The cartridge 40 and the upper body 110b may be arranged parallel to each other above the lower body 110a. The lower body 110a may face the lower portion of the cartridge 40. The upper body 110b may face the side surface of the cartridge 40. A portion of the cartridge 40 may be surrounded by the upper surface of the lower body 110a and one surface of the upper body 110b.

The light source 61 may be disposed outside the cartridge 40. The light source 61 may be disposed so as to face the cartridge 40. The light source 61 may be disposed so as to face the first container 41. The light source 61 may be mounted in the upper body 110b.

The sensor 62 may be disposed outside the cartridge 40. The sensor 62 may be disposed so as to face the cartridge 40. The sensor 62 may be disposed so as to face the first container 41. The sensor 62 may sense infrared radiation or light emitted from the interior of the first container 41. The sensor 62 may be mounted in the upper body 110b.

The controller 51 may be electrically connected to the light source 61 and the sensor 62. The controller 51 may control the operation of the light source 61 and the sensor 62. The controller 51 may receive information acquired by the sensor 62. The controller 51 may determine information about the stick based on the information acquired by the sensor 62.

The outer wall 411 and the inner wall 412 of the first container 41 may be made of a material that is capable of transmitting light. At least a portion of the outer wall 411 may include a window that is capable of transmitting light. The outer wall 411 and the inner wall 412 may be made of a material having low light reflectance, a low refractive index, and high light transmittance. The outer wall 411 may be transparent. The outer wall 411 and the inner wall 412 may be made of plastic suitable for use in an optical sensor. The outer wall 411 and the inner wall 412 may be made of polyethylene, polystyrene, Teflon, or the like. However, the present disclosure is not limited to any specific material of the outer wall 411 or the inner wall 412.

Referring to FIGS. 2 and 3, the inner wall 412 of the first container 41 may extend both in the upward-downward direction and in the circumferential direction to form the insertion space 414 therein. The insertion space 414 may be formed such that the interior of the inner wall 412 is open in the upward-downward direction. The stick 80 or 80′ may be inserted into the insertion space 414. The inner wall 412 may be disposed between the first chamber C1 and the insertion space 414. The inner wall 412 may define the insertion space. The insertion space 414 may communicate with the outside.

The insertion space 414 may have a shape corresponding to the shape of the portion of the stick 80 or 80′ that is inserted thereinto. The insertion space 414 may be elongated in the upward-downward direction. The insertion space 414 may have a cylindrical shape. When the stick 80 or 80′ is inserted into the insertion space 414, the stick 80 or 80′ may be surrounded by the inner wall 412 of the first container 41, and may come into close contact with the inner wall 412.

The outer wall 411 and the inner wall 412 of the first container 41 may be connected to each other via the upper wall 413 of the first container 41. The first chamber C1 may be defined by the outer wall 411, the inner wall 412, and the upper wall 413 of the first container 41.

The wick 31 may be disposed below the insertion space 414. The wick 31 may be disposed below the flow passage 20. The wick 31 may be connected to the first chamber C1 to receive the liquid from the chamber C1 and absorb the same. The wick 31 may be inserted into the space between the inner wall 412 of the first container 41 and the lower wall 422 of the second container 42. The wick 31 may be formed so as to extend in one direction. The wick 31 may be elongated in a leftward-rightward direction.

The heater 32 may be disposed around the wick 31. The heater 32 may be wound around the wick 31 in the direction in which the wick 31 extends. The heater 32 may apply heat to the wick. The heater 32 may generate an aerosol from the liquid absorbed in the wick 31 using an electrical resistance heating method. The heater 32 may be connected to the controller 51, so the operation thereof may be controlled by the controller 51.

The flow passage 20 may be formed between the insertion space 414 and the wick 31. The aerosol generated from the wick 31 may flow toward the insertion space 414 through the flow passage 20. The flow passage 20 may have a shape that narrows at the middle and widens at the end in the direction in which the aerosol flows. The direction in which the aerosol flows may be the upward direction.

The flow passage 20 may be surrounded by an upper passage wall 220, which protrudes inwards from the inner wall 412 of the first container 41. The upper portion of the flow passage 20 may be surrounded by the upper passage wall 220, and the lower portion of the flow passage 20 may be surrounded by a lower passage wall 210. The lower passage wall 210 may be coupled to the lower portion of the upper passage wall 220. The wick 31 may be inserted into the space between the lower passage wall 210 and the lower wall 422 of the second container 42.

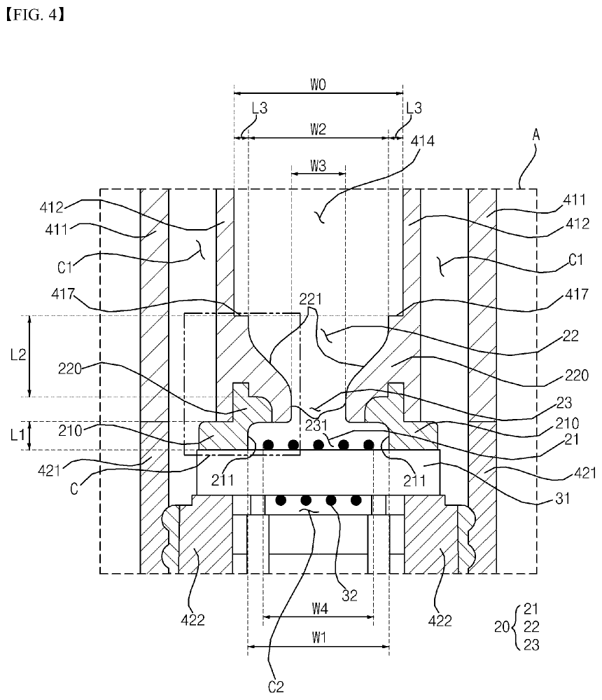

Referring to FIG. 4, the flow passage 20 may be divided into a first flow passage 21, a second flow passage 22, and a third flow passage 23.

The first flow passage 21 may be located adjacent to the wick 31. The first flow passage 21 may be disposed above the wick 31. The second flow passage 22 may be located adjacent to the insertion space 414. The second flow passage 22 may communicate with the insertion space 414.

The third flow passage 23 may be located between the first flow passage 21 and the second flow passage 22. The third flow passage 23 may be located above the first flow passage 21. The second flow passage 22 may be located above the third flow passage 23. The third flow passage 23 may cause the first flow passage 21 and the second flow passage 22 to communicate with each other therethrough.

The width W3 of the third flow passage 23 may be smaller than the width W1 of the first flow passage 21. The width W3 of the third flow passage 23 may be smaller than the width W2 of the second flow passage 22. The maximum width W1 of the first flow passage 21 and the maximum width W2 of the second flow passage 22 may be substantially equal to or similar to each other. The maximum width W1 of the first flow passage 21 may be greater than the maximum width W2 of the second flow passage 22. The width W2 of the second flow passage 22 may be smaller than the width W0 of the insertion space 414.

The width of the flow passage 20 may gradually decrease from the first flow passage 21 to the third flow passage 23. The width of the flow passage 20 may gradually increase from the third flow passage 23 to the second flow passage 22. The width W2 of the second flow passage 22 may gradually increase in a direction approaching the insertion space 414.

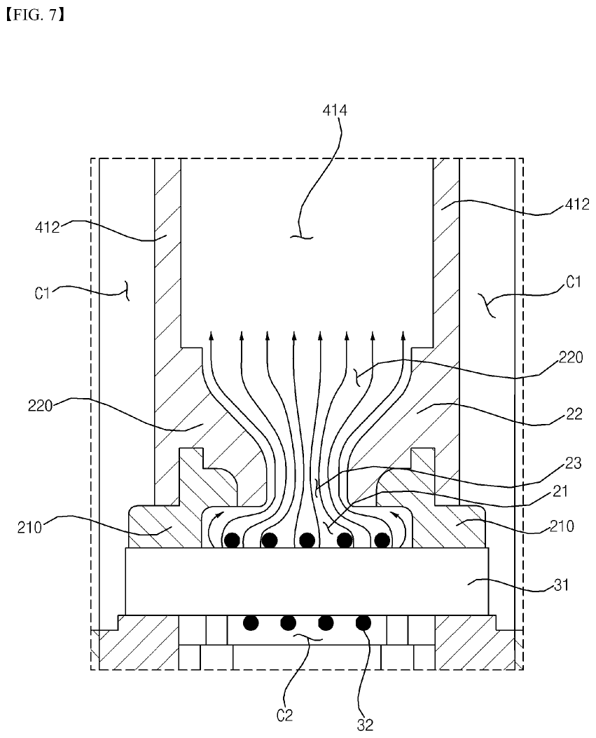

The aerosol that flows through the first flow passage 21 is concentrated in the third flow passage 23, which has a relatively small width, and is then diffused through the second flow passage 22. Accordingly, even if the aerosol is not uniformly generated from the wick 31, the aerosol may be uniformly introduced into the lower portion of the stick 80 or 80′ (refer to FIG. 2), as shown in FIG. 7.

The width W1 of the first flow passage 21 may gradually decrease in a direction approaching the third flow passage 23. The width W2 of the second flow passage 22 may gradually decrease in the direction approaching the third flow passage 23.

The degree to which the width W1 of the first flow passage 21 decreases in the direction approaching the third flow passage 23 may be greater than the degree to which the width W2 of the second flow passage 22 decreases in the direction approaching the third flow passage 23. The distance L1 by which the width of the flow passage 20 changes from the maximum width W1 of the first flow passage 21 to the width W3 of the third flow passage 23 may be shorter than the distance L2 by which the width of the flow passage 20 changes from the maximum width W2 of the second flow passage 22 to the width W3 of the third flow passage 23. That is, the ratio of the width change to the length ((W1−W3)/L1) from the first flow passage 21 to the third flow passage 23 may be greater than the ratio of the width change to the length ((W2−W3)/L2) from the second flow passage 22 to the third flow passage 23.

In other words, the first to third flow passages 21 to 23 may have the following relationship.

(W1−W3)/L1>(W2−W3)/L2

Here, “W1” represents the width of the first flow passage 21 in the leftward-rightward direction, “W2” represents the width of the second flow passage 22 in the leftward-rightward direction, “W3” represents the width of the third flow passage 23 in the leftward-rightward direction, “L1” represents the length of the first flow passage 21 in the upward-downward direction, and “L2” represents the length of the second flow passage 22 in the upward-downward direction.

The length L1 of the first flow passage 21 in the upward-downward direction may be shorter than the length L2 of the second flow passage 22 in the upward-downward direction (L1<L2).

Accordingly, it is possible to secure space for inducing the liquid to be atomized and concentrated in the third flow passage 23 while reducing the length of the first flow passage 21 and to cause the aerosol concentrated in the third flow passage 23 to be uniformly diffused and introduced into the insertion space 414 through the second flow passage 22 (refer to FIG. 7).

The length of the third flow passage 23 in the upward-downward direction may be shorter than the length L1 of the first flow passage 21 in the upward-downward direction. The length of the third flow passage 23 in the upward-downward direction may be shorter than the length L2 of the second flow passage 22 in the upward-downward direction.

The second flow passage 22 may extend from the third flow passage 23 toward the insertion space 414 such that the width W2 thereof gradually increases in the radially outward direction, and may further extend from the portion thereof at which the width W2 reaches the maximum width W2 to the insertion space 414 while maintaining the maximum width W2 substantially constant.

A first passage surface 211 may surround the first flow passage 21. A second passage surface 221 may surround the second flow passage 22. A third passage surface 231 may surround the third flow passage 23.

The first passage surface 211 may form the inner surface of the lower passage wall 210. The second passage surface 221 and the third passage surface 231 may form the inner surface of the upper passage wall 220.

The first passage surface 211 and the third passage surface 231 may be spaced apart from each other, rather than forming a continuous surface. The first passage surface 211 may extend in the upward-downward direction. The first passage surface 211 may extend in the circumferential direction. The first passage surface 211 may be formed in a ring shape.

The first flow passage 21 may extend toward the third flow passage 23 while maintaining the width W1 substantially constant, and the width W1 of the first flow passage 21 may sharply decrease to a width equivalent to the width W3 of the third flow passage 23 from the portion of the first flow passage 21 that is adjacent to the third flow passage 23 to the third flow passage 23.

Accordingly, space for the first flow passage 21 may be secured between the first passage surface 211 and the wick 31, thus making it possible to ensure smooth generation and flow of the aerosol in the space between the first passage surface 211 and the wick 31.

The third passage surface 231 may form a continuous surface with the second passage surface 221. The third passage surface 231 may extend in the upward-downward direction. The third passage surface 231 may extend in the circumferential direction. The third passage surface 231 may be formed in a ring shape.

The second passage surface 221 may include a portion that extends toward the insertion space 414 so as to gradually widen in the outward direction. The second passage surface 221 may include a portion that is inclined in the outward direction toward the insertion space 414. The second passage surface 221 may include a portion that extends toward the insertion space 414 so as to gradually widen in the radially outward direction. The second passage surface 221 may have substantially the shape of a funnel or a venturi tube.

The second passage surface 221 may extend from the third passage surface 231 toward the insertion space 414 so as to gradually widen in the outward direction, and may further extend from the portion thereof that has the maximum width W2 to the insertion space 414 while maintaining the maximum width W2 substantially constant.

The second passage surface 221 may include a portion that extends toward the insertion space 414 so as to be rounded in the outward direction. The second passage surface 221 may extend upwards from the third passage surface 231 so as to be rounded in the radially outward direction.

Accordingly, when the aerosol diffuses from the third flow passage 23 to the second flow passage 22, flow resistance may be reduced.

The width W2 of the second flow passage 22 may be maximized at the upper end of the second flow passage 22, which is contiguous with the lower end of the insertion space 414. The width W2 of the upper end of the second flow passage 22 may be smaller than the width W0 of the insertion space 414.

A protruding surface 417 may be located between the lower end of the insertion space 414 and the upper end of the second flow passage 22. The protruding surface 417 may protrude inwards from the inner wall 412 of the first container 41. The protruding surface 417 may support the edge of the lower end of the stick 80 or 80′ (refer to FIG. 2). The protruding surface 417 may protrude inwards to define the maximum width W2 of the second flow passage 22.

The protruding surface 417 may form the upper surface of the upper passage wall 220, which protrudes inwards from the inner wall 412 of the first container 41. The protruding surface 417 may extend from the inner surface of the inner wall 412 so as to be substantially perpendicular thereto. The protruding surface 417 and the inner surface of the inner wall 412 may face the insertion space 414. The second passage surface 221 may be formed so as to extend downwards from the protruding surface 417.

For example, the length L3 that the protruding surface 417 protrudes may be set to a length capable of supporting the edge of the lower end of the stick 80 or 80′ while minimizing the reduction in the flow rate of the aerosol.

The wick 31 may be disposed so as to extend in the width direction of the first flow passage 21, and the heater 32 may be wound around the wick 31 in the direction in which the wick 31 extends.

The width W1 of the first flow passage 21 may be larger than the width W4 of the heater 32. The width W3 of the third flow passage 23 may be smaller than the width W4 of the heater 32. The width direction of the flow passage 20 may be the leftward-rightward direction.

Accordingly, when the heater 32 heats the liquid absorbed in the wick 31 to generate an aerosol, even if the aerosol is not uniformly generated throughout the wick 31, the aerosol may be concentrated in the third flow passage 23, and may then be uniformly diffused from the second flow passage 22 to the insertion space 414.

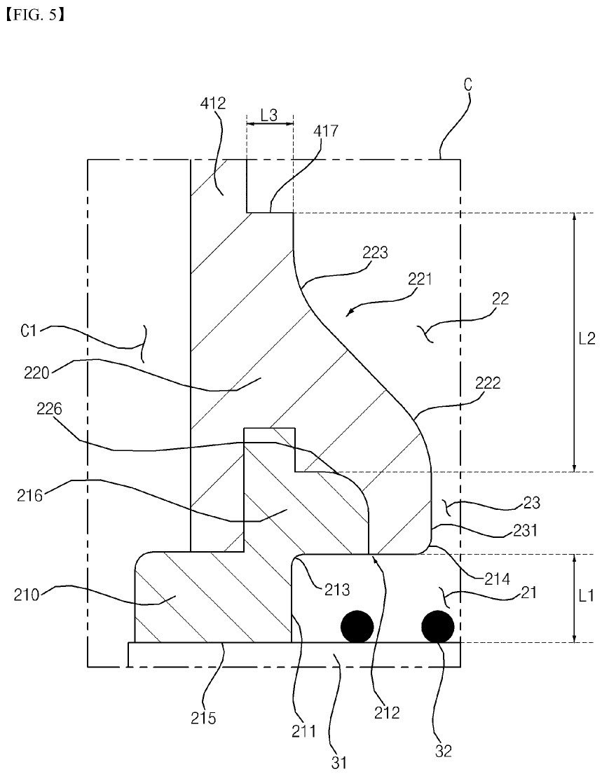

Referring to FIGS. 4 and 5, a first curved section 222 and a second curved section 223, which are formed at the second passage surface 221, may be curved so as to be convex in opposite directions.

The first curved section 222 may be formed at the lower portion of the second passage surface 221. The first curved section 222 may be formed adjacent to the third flow passage 23. The first curved section 222 may be curved so as to be convex from the third passage surface 231 toward the interior of the first container 41.

The second curved section 223 may be formed at the upper portion of the second passage surface 221. The second curved section 223 may be formed adjacent to the insertion space 414. The second curved section 223 may be curved so as to be convex from the first curved section 222 toward the outside of the first container 41. The second curved section 223 may be curved so as to be convex toward the outside of the first container 41, and may include a portion that extends from a position adjacent to the insertion space 414 to the insertion space 414 with a substantially constant width.

Accordingly, the aerosol may diffuse outwards along the first curved section 222 of the second passage surface 221, and may then flow straight into the insertion space 414 along the second curved section 223 of the second passage surface 221 (refer to FIG. 7). In addition, it is possible to reduce loss of the flow energy of the aerosol diffusing from the third flow passage 23 to the second flow passage 22.

The upper passage wall 220 may extend downwards from the inner wall 412 of the first container 41. The upper passage wall 220 may have a shape that protrudes inwards from the inner wall 412. The second passage surface 221 and the third passage surface 231 may form the inner surface of the upper passage wall 220.

The lower passage wall 210 may be coupled to the lower portion of the upper passage wall 220. The first passage surface 211 may form the inner surface of the lower passage wall 210.

A groove portion 226 may be formed in the lower portion of the upper passage wall 220. The groove portion 226 may be formed so as to be recessed upwards in the lower portion of the upper passage wall 220.

The insertion portion 216 may be formed at the upper portion of the lower passage wall 210. The insertion portion 216 may be formed above the first passage surface 211.

The insertion portion 216 may be formed so as to protrude upwards from the upper portion of the lower passage wall 210. The insertion portion 216 may be inserted into the groove portion 226 so as to be in close contact therewith. When the insertion portion 216 is inserted into the groove portion 226, the upper passage wall 220 and the lower passage wall 210 may be coupled to each other. The lower passage wall 210 may be removably coupled to the lower portion of the upper passage wall 220.

The lower passage wall 210 may define the width W1 (refer to FIG. 4) of the first flow passage 21. The width W1 of the first flow passage 21 may vary depending on the extent to which the first passage surface 211, which forms the inner surface of the lower passage wall 210, is depressed in the leftward-rightward direction.

As the first passage surface 211 of the lower passage wall 210 is located further inwards, the width W1 of the first flow passage 21 may decrease. As the first passage surface 211 of the lower passage wall 210 is located further outwards, the width W1 of the first flow passage 21 may increase.

Accordingly, the width W1 of the first flow passage 21 may be defined or changed according to the shape of the lower passage wall 210, which is coupled to the upper passage wall 220.

Accordingly, the area of the wick 31, in which the liquid is atomized, may be defined by setting the length W1 of the portion of the wick 31 that is exposed to the first flow passage 21 and the width W4 of the portion of the wick 31, around which the heater 32 is wound.

The first passage surface 211 may extend in the upward-downward direction. The first passage surface 211 may be formed substantially perpendicular to the wick 31. The first passage surface 211 may define the length L1 of the first flow passage 21.

An extended surface 212 may form a portion of the inner surface of the upper passage wall 220 and a portion of the inner surface of the lower passage wall 210. The extended surface 212 may be formed between the first passage surface 211 and the third passage surface 231.

The extended surface 212 may be connected to the upper end of the first passage surface 211. The extended surface 212 may be connected to the lower end of the third passage surface 231. The extended surface 212 may be referred to as a connection surface 212. The extended surface 212 may be formed so as to extend from the upper end of the first passage surface 211 in the leftward-rightward direction. The extended surface 212 may be formed so as to extend from the lower end of the third passage surface 231 in the leftward-rightward direction.

The extended surface 212 may be spaced upwards apart from the wick 31. The extended surface 212 may be disposed in the width direction of the first flow passage 21. The extended surface 212 may extend from the upper end of the first passage surface 211 toward the third flow passage 23. The extended surface 212 may connect the first passage surface 211 to the third passage surface 231. The extended surface 212 may be spaced apart from the wick 31, and may face the wick 31.

The spacing distance between the extended surface 212 and the wick 31 may be substantially equal to the height L1 of the first flow passage 21. The extended surface 212 may be disposed opposite the wick 31 with respect to the first flow passage 21. The extended surface 212 may be disposed substantially parallel to the wick 31. The extended surface 212 may be formed substantially perpendicular to the first passage surface 211. The extended surface 212 may be formed substantially perpendicular to the third passage surface 231.

An end portion of the first flow passage 21 may be surrounded by the first passage surface 211, the wick 31, and the extended surface 212. The aerosol atomized at the end portion of the wick 31 may remain in the end portion of the first flow passage 21.

Accordingly, a space in which the aerosol atomized at the end portion of the wick 31 can gather may be formed, and suction force may effectively act on the end portion of the wick 31, as well as the middle portion thereof.

Also, since turbulence is formed in the end portion of the first flow passage 21 by the aerosol atomized at the end portion of the wick 31, even if the aerosol is not uniformly generated throughout the wick 31, the aerosol may be evenly distributed (refer to FIG. 7).

A first edge portion 213 may be formed between the first passage surface 211 and the extended surface 212. The first edge portion 213 may be contiguous with the edge portion of the upper end of the first flow passage 21. The first edge portion 213 may extend in a rounded form from the first passage surface 211 to the extended surface 212.

A second edge portion 214 may be formed between the extended surface 212 and the third passage surface 231. The second edge portion 214 may be formed at a position between the first flow passage 21 and the third flow passage 23 so as to be adjacent thereto. The second edge portion 214 may extend in a rounded form from the extended surface 212 to the third passage surface 231.

Accordingly, it is possible to reduce loss of the flow energy of the aerosol diffusing from the first flow passage 21 to the third flow passage 23.

A wick insertion surface 215 may form the lower end of the lower passage wall 210. The wick insertion surface 215 may extend in the width direction of the first flow passage 21. The wick insertion surface 215 may form an opening having a shape corresponding to the shape of the end portion of the wick 31 so that the wick 31 is inserted thereinto. The wick insertion surface 215 may be connected to the first passage surface 211.

The wick 31 may be inserted into the space between the wick insertion surface 215 and the lower wall 422 of the second container 42. When the wick 31 is inserted, the wick insertion surface 215 may directly contact the upper end of the wick 31. The wick insertion surface 215 may be in close contact with the wick 31, thus preventing the liquid from leaking to the outside.

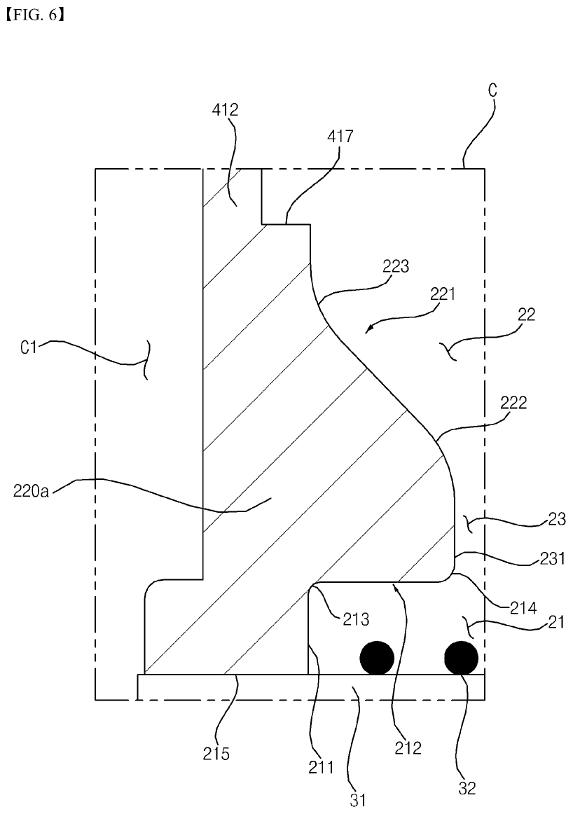

Referring to FIG. 6, the upper passage wall 220 (refer to FIG. 5) and the lower passage wall 210 (refer to FIG. 5) described above may be integrated to form a passage wall 220a, rather than being coupled to each other. The shape of the passage wall 220a may be substantially the same as the overall shape of the assembly of the upper passage wall 220 and the lower passage wall 210.

Accordingly, a process of coupling the components to each other may be eliminated, and leakage of the liquid through a gap between components that are coupled to each other may be prevented.

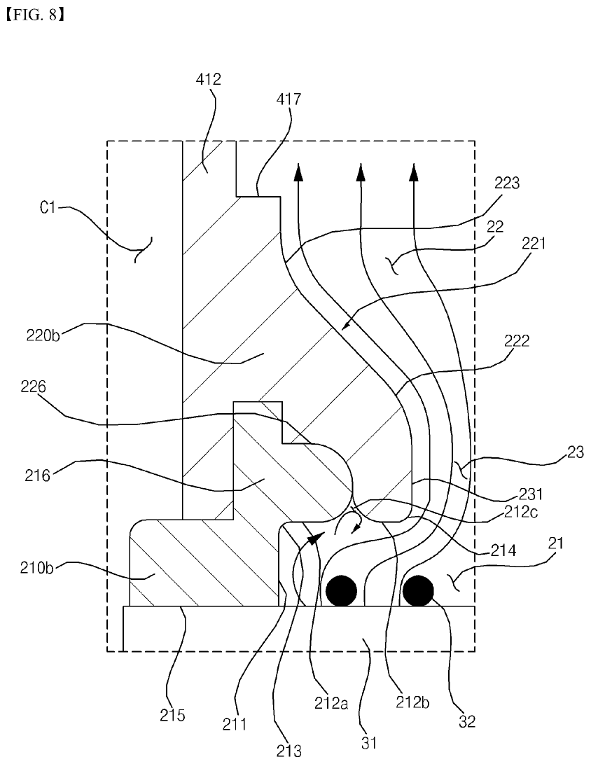

Referring to FIG. 8, a first extended surface 212a may form a portion of the inner surface of the lower passage wall 210b. The first extended surface 212a may be contiguous with the first flow passage 21. The first extended surface 212a may be connected to the upper end of the first passage surface 211. The first extended surface 212a may extend from the upper end of the first passage surface 211 in the leftward-rightward direction. The first edge portion 213 may be formed between the first passage surface 211 and the first extended surface 212a.

A second extended surface 212b may form a portion of the inner surface of the upper passage wall 220b. The second extended surface 212b may be contiguous with the first flow passage 21. The second extended surface 212b may be connected to the lower end of the third passage surface 231. The second extended surface 212b may extend from the lower end of the third passage surface 231 in the leftward-rightward direction. The second edge portion 214 may be formed between the first extended surface 212b and the third passage surface 231.

A depressed portion 212c may be formed between the first extended surface 212a and the second extended surface 212b so as to be depressed upwards to a predetermined depth. The depressed portion 212c may be formed between the portion of the lower passage wall 210b and the portion of the upper passage wall 220b that are coupled to each other. The depressed portion 212c may face the upper portion of the first flow passage 21.

Accordingly, turbulence caused by the aerosol atomized at the end portion of the wick 31 may be formed to a greater extent in the vicinity of the depressed portion 212c. Therefore, even if the aerosol is not uniformly generated throughout the wick 31, the aerosol may be evenly distributed.

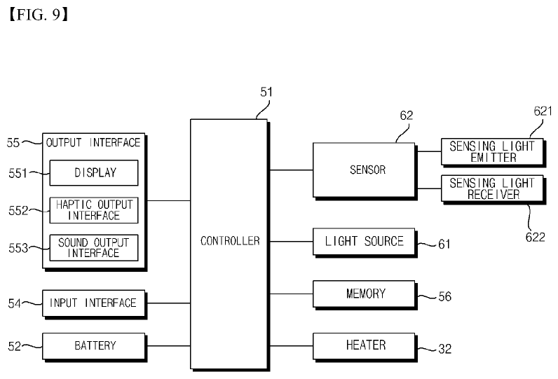

Referring to FIG. 9, the controller 51 may be electrically connected to various components. The controller 51 may control the components connected thereto.

The aerosol-generating device 100 may include an output interface 55. The controller 51 may be electrically connected to the output interface 55. The output interface 55 may provide a user with various pieces of information, such as information about on/off operation of the power supply, information about whether the heater 32 is operating, information about the stick, information about the liquid, and information about the state of charge of the battery. The controller 51 may control the output interface 55 to provide information to the user based on various pieces of information received from the components.

The output interface 55 may include a display 551. The display 551 may display information to the outside to provide the same to the user.

The output interface 55 may include a haptic output interface 552. The haptic output interface 552 may provide information to the user through vibration. The haptic output interface 552 may include a vibration motor.

The output interface 55 may include a sound output interface 553. The sound output interface 553 may output a sound corresponding to information to provide the information to the user. The sound output interface 553 may include a speaker.

The aerosol-generating device 100 may include an input interface 54. The controller 51 may be electrically connected to the input interface 54. The user may input various commands, such as turning on or turning off of the power supply and activation or deactivation of the heater 32, to the input interface 54. The controller 51 may receive a command from the input interface 54 to control the operation of the components.

The aerosol-generating device 100 may include a memory 56. The controller 51 may be electrically connected to the memory 56. The memory 56 may store therein data on information. The memory 56 may receive and store data on various pieces of information from the controller 51, or may transmit stored data to the controller 51. The controller 51 may control the operation of the components based on data received from the memory 56.

The controller 51 may be electrically connected to the sensor 62. The sensor 62 may be an infrared sensor 62 or a color sensor 62. The infrared sensor 62 may sense infrared radiation emitted from the interior of the first container 41. The color sensor 62 may sense light emitted from the interior of the first container 41. The color sensor 62 may acquire color information from the sensed light.

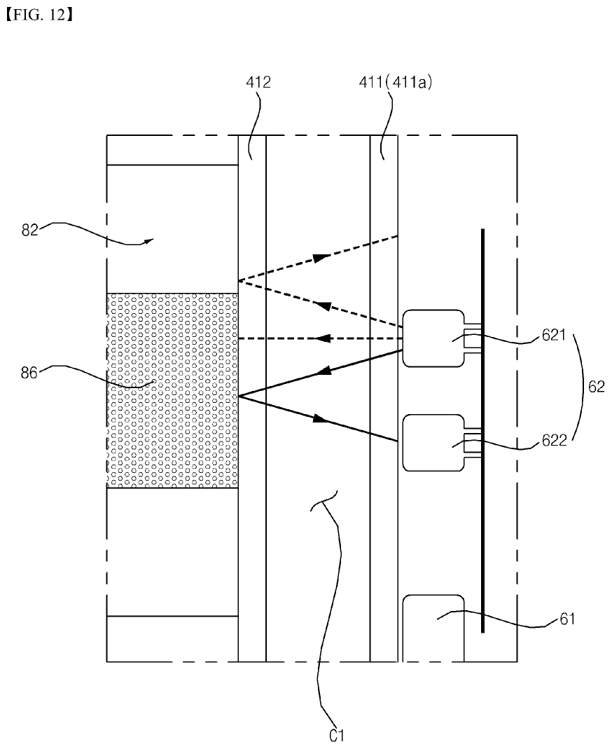

The sensor 62 may include a sensing light emitter 621 and a sensing light receiver 622. The sensing light emitter 621 may emit infrared radiation or light (hereinafter referred to as a wavelength) toward the interior of the first container 41. The wavelength emitted from the sensing light emitter 621 may sequentially pass through the outer wall 411 of the first container 41, the first chamber C1, and the inner wall 412 of the first container 41, and may be reflected from the stick (refer to FIG. 12). The reflected wavelength may sequentially pass through the inner wall 412, the first chamber C1, and the outer wall 411, and may reach the sensing light receiver 622 (refer to FIG. 12). The sensing light receiver 622 may sense the wavelength reflected from an object to thereby acquire information about the same.

The wavelength emitted from the sensor 62 may pass through the liquid charged in the first container 41 depending on the amount of liquid therein. Alternatively, the wavelength emitted from the sensor 62 may pass through the liquid depending on the extent to which the user tilts the aerosol-generating device. The liquid charged in the first container 41 may be a colorless and transparent liquid. Accordingly, even if the wavelength emitted from the sensor 62 passes through the liquid, this may have little influence on the color information.

The controller 51 may receive information about the wavelength from the sensor 62. The controller 51 may determine information about the stick by analyzing a value output by the sensor 62 according to the information about the wavelength that is acquired.

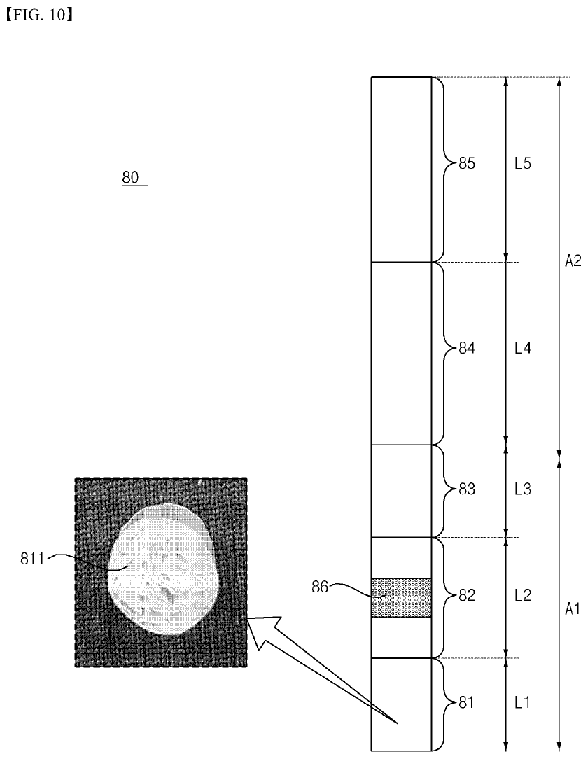

Referring to FIG. 10, a plug 81 may be disposed at a lower portion of the stick 80′. A granulation section 82 may be disposed between the plug 81 and a filter section 83.

A filter 811 may be disposed inside the plug 81. The filter 811 may be formed of a paper material. The filter 811 may be formed by crumpling a long sheet of paper. Since the filter 811, which has a crumpled paper shape, has wrinkles therein, gaps may be formed between the wrinkles.

Accordingly, when the aerosol flows, a portion of the aerosol may enter the granulation section 82 while wetting the filter 811, and the remaining portion of the aerosol may enter the granulation section 82 while passing through the gaps between the wrinkles of the filter 811.

Accordingly, when the aerosol flows, the aerosol may wet the filter 811, and may thus wet the surface of the stick 80′.

A medium may be contained in the granulation section 82. The aerosol-generating device may extract a certain component from the medium by forming an aerosol. The granulation section 82 may be disposed on the plug 81.

The filter section 83 may be disposed on the granulation section 82. A filter may be included in the filter section 83. The filter may be a cellulose acetate filter.

The hollow section 84 may be disposed on the filter section 83. The hollow section 84 may have the shape of a hollow tube.

A mouthpiece 85 may be disposed at the upper end of the stick 80′. The mouthpiece 85 may be disposed on the hollow section 84. A filter may be included in the mouthpiece 85. The filter may be a cellulose acetate filter. The plug 81, the granulation section 82, the filter section 83, the hollow section 84, and the mouthpiece 85 may be surrounded by a wrapper. The wrapper may be made of a paper material. The wrapper may be white.

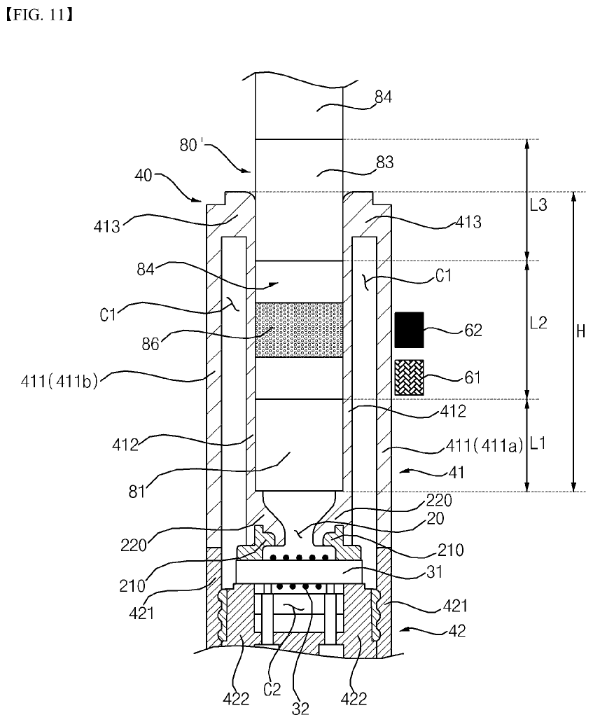

Referring to FIGS. 10 and 11, when the stick 80′ is inserted into the insertion space 414 (refer to FIG. 3), the plug 81 may be disposed in the lower end portion of the insertion space 414. When the stick 80′ is inserted into the insertion space 414, the granulation section 82 may be disposed in the insertion space 414. When the stick 80′ is inserted, at least a portion of the filter section 83 may be disposed in the insertion space 414.

When the stick 80′ is inserted into the insertion space 414, the hollow section 84 may be exposed to the outside. When the stick 80′ is inserted into the insertion space 414, the mouthpiece 85 may be exposed to the outside.

The insertion space 414 may have a height H that allows at least a portion of the filter section 83 to be disposed in the insertion space 414 when the stick 80′ is completely inserted into the insertion space 414. The height H of the insertion space 414 may be greater than the length from the lower end of the plug 81 to the upper end of the granulation section 82. The height H of the insertion space 414 may be less than the length from the lower end of the plug 81 to the upper end of the filter section 83.

The length L1 of the plug 81 in the upward-downward direction may be about 7 mm. The length L2 of the granulation section 82 in the upward-downward direction may be about 10 mm. The length L3 of the filter section 83 in the upward-downward direction may be about 7 mm. The length L4 of the hollow section 84 in the upward-downward direction may be about 12 mm. The length L5 of the mouthpiece 85 in the upward-downward direction may be about 12 mm.

The height H of the insertion space 414 may be 17 mm or more. The height H of the insertion space 414 may be 24 mm or less. The height H of the insertion space 414 may be 22 mm.

The stick 80′ may be divided into a first area A1 and a second area A2. The first area A1 may be disposed in the insertion space 414 when the stick 80′ is inserted into the insertion space 414. The second area A2 may be exposed to the outside when the stick 80′ is inserted into the insertion space 414. The length of the first area A1 may correspond to the height H of the insertion space 414.

The first area A1 may include the plug 81 and the granulation section 82. The first area A1 may include at least a portion of the filter section 83. The second area A2 may include the hollow section 84 and the mouthpiece 85. The second area A2 may include at least a portion of the filter section 83.

A marker 86 may be formed on the wrapper of the stick 80′. The marker 86 may be printed on a portion of the wrapper, or may be printed so as to extend in the peripheral direction of the wrapper.

The marker 86 may be located on the surface of at least a portion of the portion of the stick 80′ that is inserted into the insertion space 414. The marker 86 may be formed in the first area A1 of the stick 80′. The marker 86 may be formed at a position corresponding to at least one of the plug 81, the granulation section 82, or the filter section 83 in the first area A1.

The marker 86 may have a color different from the color of the wrapper of the stick 80′. The marker 86 may have light reflectance different from the light reflectance of the wrapper. For example, the wrapper may be white, and the marker 86 may be blue.

For example, the marker 86 may be a portion of the wrapper of the stick 80′. Alternatively, the marker 86 may be an area on which the light emitted from the sensing light emitter 621 of the sensor 62 is incident.

For example, the marker 86 may be a band formed along the periphery of the stick 80′. Accordingly, the sensor 62 is capable of sensing the marker 86 irrespective of the direction in which the marker 86 is oriented when the stick 80′ is inserted into the insertion space 414.

Referring to FIG. 11, the sensor 62 may be disposed outside the cartridge 40. The sensor 62 may be disposed outside the outer wall 411 of the first container 41. The sensor 62 may be disposed so as to face the outer wall 411. The sensor 62 may be disposed adjacent to the outer wall 411. The sensor 62 may be disposed so as to face the insertion space 414 (refer to FIG. 3). The sensor 62 may sense the light emitted from the interior of the first container 41.

The sensor 62 may be disposed at a height close to the height at which the marker 86 is located when the stick 80′ is inserted into the insertion space 414. At least one sensor 62 may be disposed outside the first container 41 at a position corresponding to the region between the upper end and the lower end of the first chamber C1. The at least one sensor 62 may be disposed outside the first container 41 at a position corresponding to the region between the upper end and the lower end of the insertion space 414. The at least one sensor 62 may be disposed outside the first container 41 at a position corresponding to the region above the protruding surface 417.

Referring to FIG. 12, the sensor 62 may be a color sensor 62. The color sensor 62 may include a sensing light emitter 621, which emits light toward the interior of the first container 41. The sensing light emitter 621 may emit white light, which is obtained by combining three primary colors of light, i.e. red (R), green (G), and blue (B) colors. The color sensor 62 may include a sensing light receiver 622, which receives the light. The white light emitted from the sensing light emitter 621 may be reflected from an object, and may then be introduced into the sensing light receiver 622. The sensing light receiver 622 may acquire color information from the light introduced thereinto. The sensing light receiver 622 may output an RGB value corresponding to the color of the light introduced thereinto.

The sensor 62 may be an infrared sensor 62. The infrared sensor 62 may include a sensing light emitter 621, which emits infrared radiation toward the interior of the first container 41. The infrared sensor 62 may include a sensing light receiver 622, which receives the infrared radiation. The infrared radiation emitted from the sensing light emitter 621 may be reflected from an object, and may then be introduced into the sensing light receiver 622. The sensing light receiver 622 may acquire information about the infrared radiation introduced thereinto.

The sensing light emitter 621 may emit a wavelength toward the insertion space 414. The sensing light emitter 621 may emit a wavelength toward the stick 80 or 80′ inserted into the insertion space 414. The sensing light emitter 621 may emit a wavelength toward the marker 86 of the stick 80′.

The wavelength emitted from the sensing light emitter 621 may be reflected from the stick 80 or 80′, and may then be introduced into the sensing light receiver 622. The wavelength emitted from the sensing light emitter 621 may be reflected from the marker 86 of the stick 80′, and may then be introduced into the sensing light receiver 622.

At least a portion of the outer wall 411 and at least a portion of the inner wall 412 of the first container 41 may be made of a material that transmits a wavelength. For example, the outer wall 411 and the inner wall 412 may be made of a material having low reflectance, a low refractive index, and high transmittance with respect to wavelengths.

The wavelength emitted from the sensing light emitter 621 may sequentially pass through the outer wall 411 of the first container 41, the first chamber C1, and the inner wall 412 of the first container 41. The light that has passed through the above components may be reflected from the stick 80 or 80′, and may then sequentially pass through the inner wall 412 of the first container 41, the first chamber C1, and the outer wall 411 of the first container 41. The reflected light may be introduced into the sensing light receiver 622.

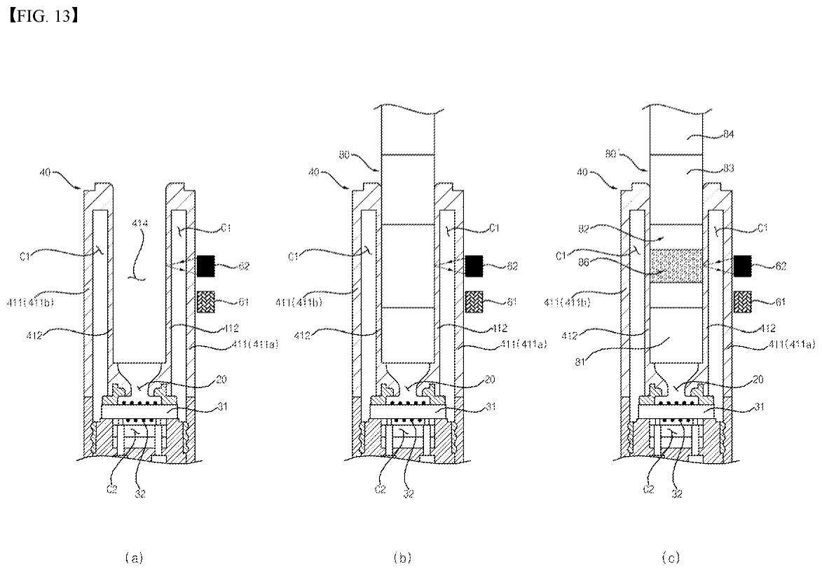

Referring to FIG. 13, the information sensed by the sensor 62 may vary depending on whether the stick is inserted and on the type of stick.

Referring to FIG. 13(a), in the state in which the stick 80 or 80′ is not inserted into the insertion space 414, the sensor 62 may sense the wavelength reflected from the first container 41 and the cap 120 (refer to FIG. 2).

The stick 80 on which the marker 86 is not marked may be referred to as a first stick 80. The stick 80′ on which the marker 86 is marked may be referred to as a second stick 80′.

As shown in FIGS. 13(b) and 13(c), in the state in which the stick 80 or 80′ is inserted into the insertion space 414, the wavelength emitted from the sensor 62 may be reflected from the stick 80 or 80′, and may then be introduced back into the sensor 62. The wavelength reflected from the marker 86 of the second stick 80′ (FIG. 13(c)) may be different from the wavelength reflected from the first stick 80 (FIG. 13(b)). When the first stick 80 is inserted into the insertion space 414, the sensor 62 may sense the wavelength reflected from the first stick 80 (FIG. 13(b)). When the second stick 80′ is inserted into the insertion space 414, the sensor 62 may sense the color of the marker 86 of the second stick 80′ (FIG. 13(c)).

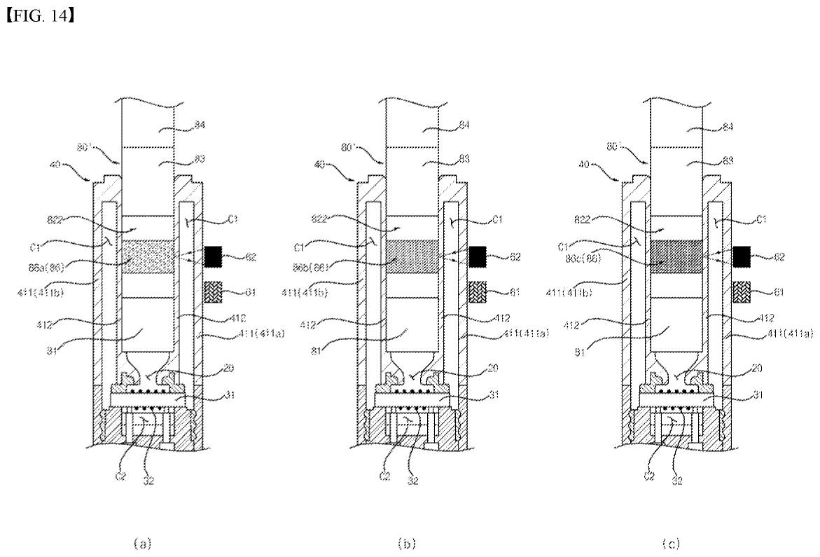

Referring to FIG. 14, when the aerosol flows into the second stick 80′, the marker 86 may be wet by the aerosol, and may change in color. The color of the marker 86 may be permanently changed by the aerosol. That is, even if the stick 80′ through which the aerosol has passed dries, the marker 86 may maintain the ability to change the color thereof. As the amount of aerosol introduced increases, the color of the marker 86 may become darker. The wavelength reflected from the marker 86 may vary depending on the color of the marker 86. The information about the wavelength acquired by the sensor 62 may vary depending on changes in the color of the marker 86.

When the second stick 80′ is not used (FIG. 14(a)), the color of the marker 86a may not change, and at this time, the color of the marker 86a may be the brightest. Here, use of the stick 80 or 80′ may mean that vaporized aerosol passes through the stick 80 or 80′. When a certain amount of aerosol is introduced into the second stick 80′ (FIG. 14(b)), the color of the marker 86b may become darker than in the case shown in FIG. 14(a). When a larger amount of aerosol than the case shown in FIG. 14(b) is introduced into the second stick 80′ (FIG. 14(c)), the color of the marker 86c may become darker than in the case shown in FIG. 14(b).

Accordingly, the color information acquired by the sensor 62 may vary depending on the extent to which the stick 80′ is used.

The controller 51 may determine whether the stick 80 or 80′ inserted into the insertion space 414 is a spent stick based on the information acquired by the sensor 62. Upon determining that the stick 80 or 80′ inserted into the insertion space 414 is a spent stick, the controller 51 may control the output interface 55 to output a message indicating that the stick is unusable. Alternatively, upon determining that the stick 80 or 80′ inserted into the insertion space 414 is a spent stick, the controller 51 may interrupt the supply of power to the heater 32. Accordingly, even if the user holds the stick 80 or 80′ in the mouth and tries to inhale the aerosol, the user may be unable to inhale the aerosol.

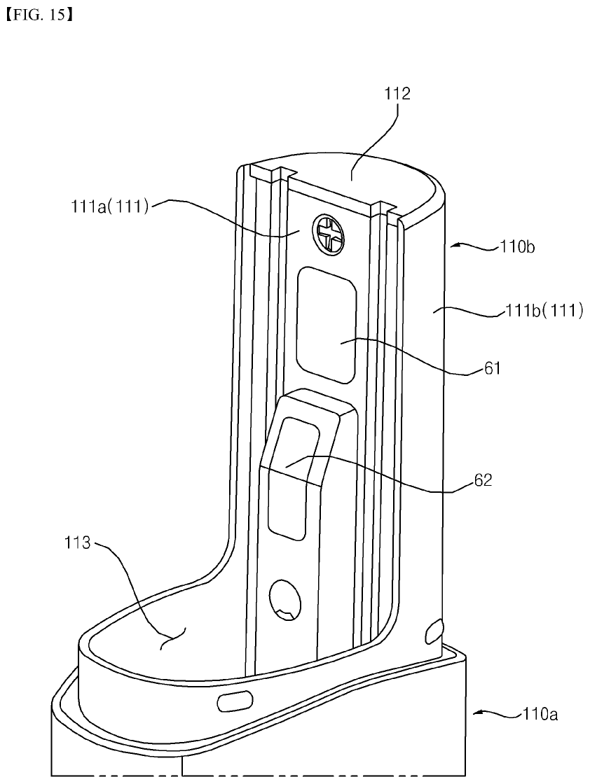

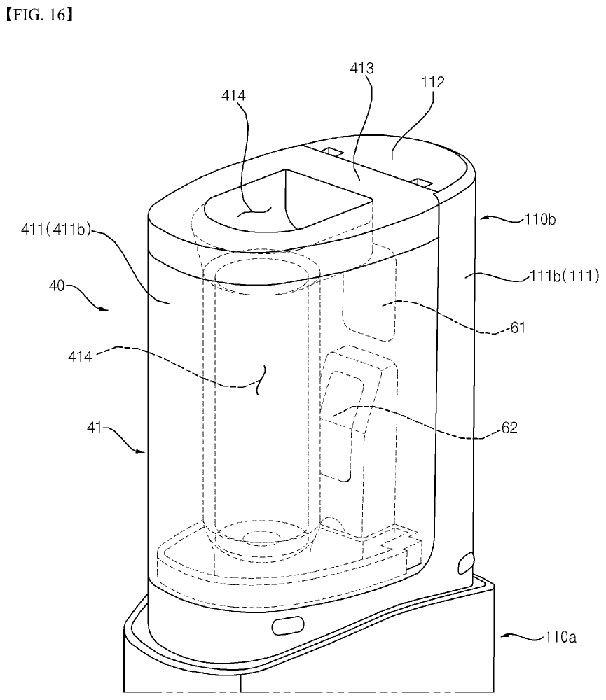

Referring to FIGS. 15 and 16, the cartridge 40 may be removably fitted into a mounting/demounting space 113, which is formed between the lower body 110a and the upper body 110b. The second container 42 (refer to FIG. 1) may be inserted into the mounting/demounting space 113. The cartridge 40 and the upper body 110b may be disposed parallel to each other above the lower body 110a so as to face each other. The insertion space 414 may be formed in the first container 41. The insertion space 414 may be elongated in the upward-downward direction.

The sidewall 111 of the upper body 110b may include a first sidewall 111a and a second sidewall 111b. The first sidewall 111a of the upper body 110b may face the side surface of the cartridge 40. The first sidewall 111a of the upper body 110b may face the interior of the aerosol-generating device 100.

The second sidewall 111b of the upper body 110b may be disposed so as to face the first sidewall 111b. The second sidewall 111b of the upper body 110b may face the outside of the aerosol-generating device 100. The second sidewall 111b of the upper body 110b may not face the cartridge 40.

The outer wall 411 of the first container 41 may include a first outer wall 411a and a second outer wall 411b. The first outer wall 411a of the first container 41 may face the upper body 110b. The first outer wall 411a of the first container 41 may face the first sidewall 111a of the upper body 110b. The first outer wall 411a of the first container 41 may face the interior of the aerosol-generating device 100. The first outer wall 411a may be referred to as a first outer sidewall 411a or a first sidewall 411a.

The second outer wall 411b of the first container 41 may be disposed so as to face the first outer wall 411a. The second outer wall 411b of the first container 41 may face the outside of the aerosol-generating device 100. The second outer wall 411b of the first container 41 may not face the upper body 110b. The second outer wall 411b may be referred to as a second outer sidewall 411b or a second sidewall 411b.

The light source 61 may be disposed outside the cartridge 40. The light source 61 may be disposed adjacent to the cartridge 40. The light source 61 may provide light to the cartridge 40.

The light source 61 may be disposed adjacent to the first container 41. The light source 61 may be disposed adjacent to the side surface of the first container 41. The light source 61 may provide light to the first container 41. The light source 61 may be disposed so as to face the first container 41. The light source 61 may face the first outer wall 411a of the first container 41.

The light source 61 may be mounted in the upper body 110b. The light source 61 may be mounted so as to face away from the first sidewall 111a of the upper body 110b toward the first container 41.

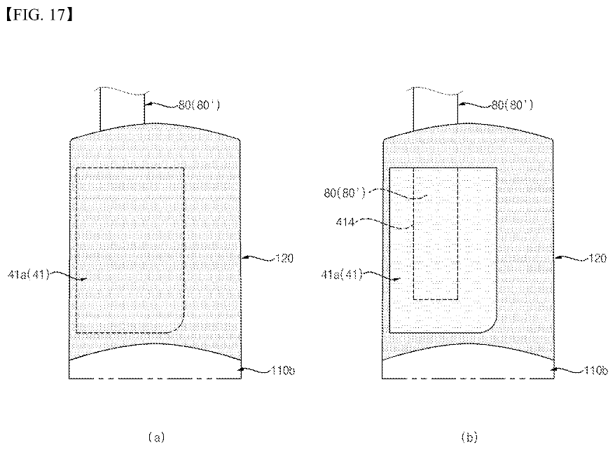

Referring to FIG. 17, the cap 120 may cover the upper body 110b (refer to FIG. 16) and the cartridge 40. At least a portion of the cap 120 may include a portion that is capable of transmitting light. The portion of the cap 120 that covers the first container 41 may be made of a material that is capable of transmitting light. The portion of the cap 120 that surrounds the insertion space 414 may be made of a material that is capable of transmitting light. At least a portion of the sidewall 121 of the cap 120 may be made of a material that is capable of transmitting light.

Referring to FIG. 17(a), when the light source 61 is not operating, light may not be emitted from the interior of the cap 120. The first container 41a, which is disposed inside the cap 120, may be invisible or only faintly visible from outside the cap 120.

Referring to FIG. 17(b), when the light source 61 operates, the light source 61 may provide light to the cartridge 40. The light emitted from the light source 61 may sequentially pass through the cartridge 40 and the cap 120. The light that has passed through the cartridge 40 may diffuse from the interior of the cap 120 to the outside. The first container 41b may be visible from outside the cap 120. The insertion space 414 may be visible from outside the cap 120.

Accordingly, the user may more clearly check the amount of liquid stored in the cartridge 40 with the naked eye in the state in which the cap 120 is coupled. Also, the user may check the amount of liquid stored in the cartridge 40 even in a dark environment. Also, the aerosol-generating device 100 may provide various aesthetic effects depending on the color of the light emitted from the light source 61. Also, the user may check the state of the stick 80 or 80′ inserted into the insertion space 414.

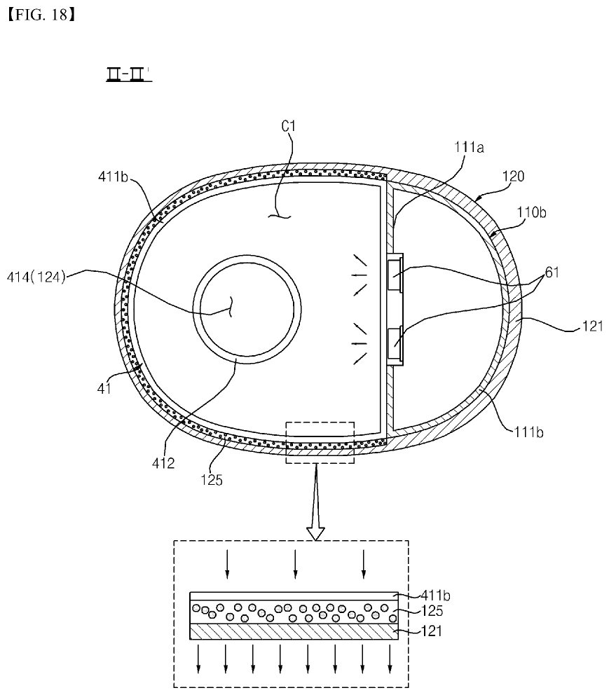

Referring to FIGS. 17 and 18, the light source 61 may face the first container 41. The light source 61 may face the insertion space 414. A portion of the first chamber C1 may be located between the insertion space 414 and the light source 61.

The first sidewall 111a of the upper body 110b may face the first outer wall 411a of the first container 41. The light source 61 may be disposed so as to face away from the first sidewall 111a of the upper body 110b toward the first outer wall 411a of the first container 41.

The sidewall 121 of the cap 120 may surround the second outer wall 411b of the first container 41 and the second sidewall 111b of the upper body 110b. The cap 120 may include a diffusion sheet 125. The diffusion sheet 125 may be included in at least a portion of the cap 120. The diffusion sheet 125 may be disposed along the periphery of at least a portion of the sidewall 121 of the cap 120. The diffusion sheet 125 may face or surround at least a portion of the second outer wall 411b of the first container 41. The diffusion sheet 125 may be disposed outside the second outer wall 411b of the first container 41. The diffusion sheet 125 may be disposed between the sidewall 121 of the cap 120 and the second outer wall 411b of the first container 41.

The diffusion sheet 125 may serve to diffuse light. The diffusion sheet 125 may make at least a portion of the surface of the cap 120 hazy. The diffusion sheet 125 may receive light from the light source 61, and may diffuse the light toward the outside of the cap 120. The diffusion sheet 125 may diffuse the external light introduced into the cap 120 from the outside of the cap 120.

Accordingly, when the light source 61 is not operating, it is possible to minimize the introduction of light, such as ultraviolet radiation, into the cap 120, thus preventing the liquid stored in the first container 41 from deteriorating. In addition, when the light source 61 operates, the light emitted from the light source 61 may diffuse to the outside of the cap 120, thus enabling the user to more clearly view the liquid stored in the first container 41 or the stick 80 or 80′ inserted into the insertion space 414.

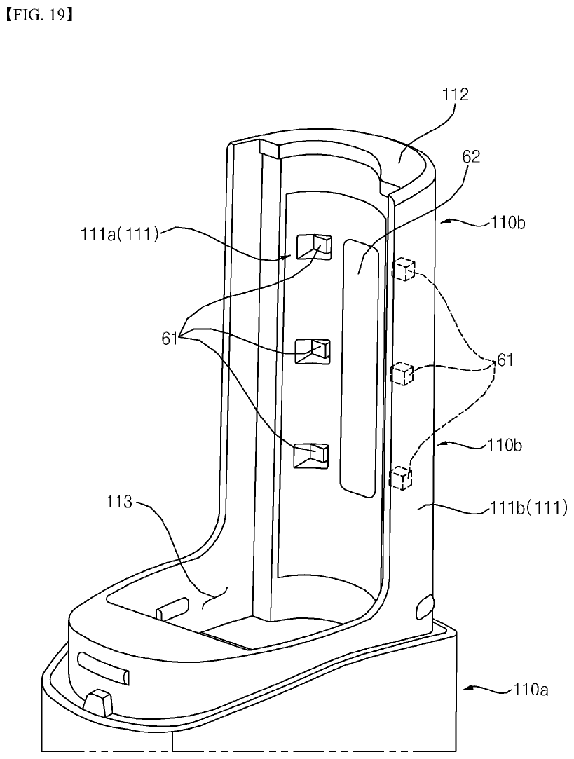

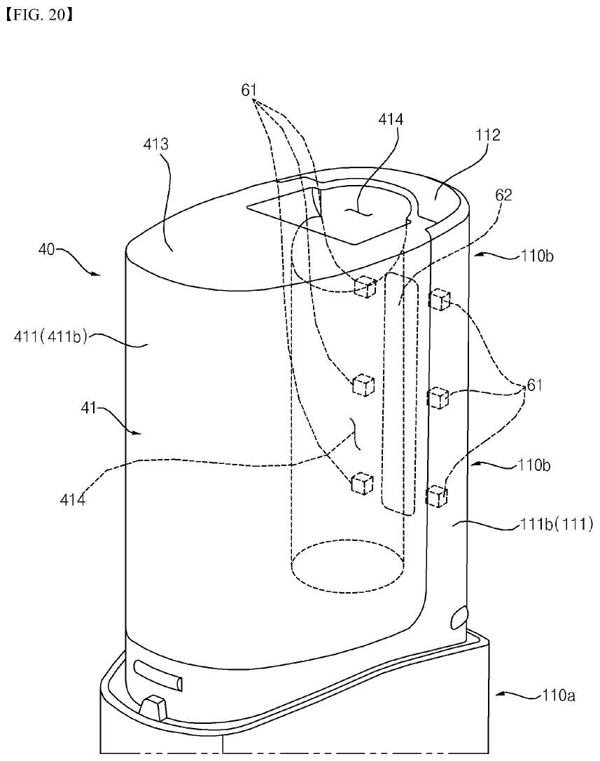

Referring to FIGS. 19 to 21, the light source 61 may be provided in a plural number. The light sources 61 may be arranged in the upper body 110b in the upward-downward direction. The first sidewall 111a of the upper body 110b may be depressed so as to be concave toward the second sidewall 111b of the upper body 110b. The first outer wall 411a of the first container 41 may have a shape corresponding to the shape of the first sidewall 111a, that is, may protrude so as to be convex toward the first sidewall 111a. The first outer wall 411a of the first container 41 may be surrounded by the first sidewall 111a of the upper body 110b.

The insertion space 414 may be disposed in the first container 41 so as to be adjacent to the upper body 110b. The insertion space 414 may be disposed adjacent to the first sidewall 411a of the first container 41. The first sidewall 411a of the first container 41 may surround the portion of the inner wall 412 that defines the insertion space 414.

The light sources 61 may face the first container 41. The light sources 61 may face the outside of the insertion space 414. The light sources 61 may emit light toward the first chamber C1, which is located between the insertion space 414 and the second outer wall 411b of the first container 41.

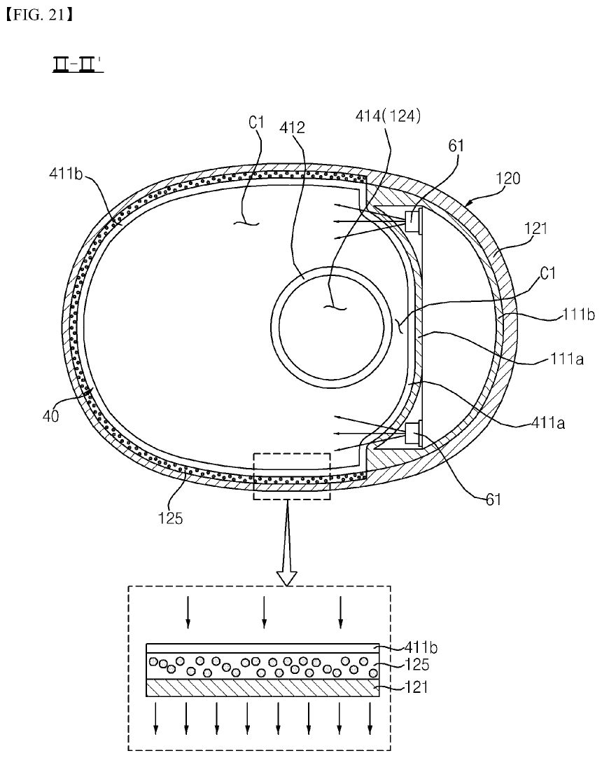

The light sources 61 may be disposed opposite each other with respect to the insertion space 414 (refer to FIG. 21). The direction in which the light source 61 disposed on one side is oriented and the direction in which the light source 61 disposed on the opposite side is oriented may be parallel to each other. The insertion space 414 may be disposed between the direction in which the light source 61 disposed on one side is oriented and the direction in which the light source 61 disposed on the opposite side is oriented.

Accordingly, the light emitted from the light sources 61 may diffuse to the outside of the cap 120 without being blocked by the stick 80 or 80′ inserted into the insertion space 414.

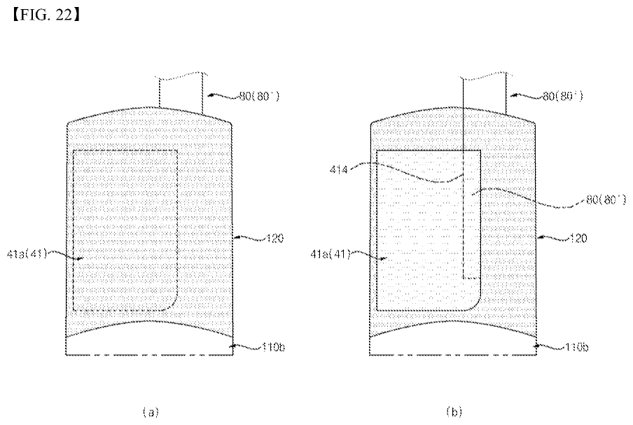

Referring to FIG. 22(a), when the light sources 61 are not operating, light may not diffuse from the interior of the cap 120. The first container 41a, which is disposed inside the cap 120, may be invisible or only faintly visible from outside the cap 120.

Referring to FIG. 22(b), when the light sources 61 operate, the light sources 61 may provide light to the cartridge 40. The light emitted from the light sources 61 may sequentially pass through the cartridge 40 and the cap 120. The light that has passed through the cartridge 40 may diffuse from the interior of the cap 120 to the outside. The first container 41b may be visible from outside the cap 120. The insertion space 414 may be visible from outside the cap 120.

Accordingly, the user may more clearly check the amount of liquid stored in the cartridge 40 with the naked eye in the state in which the cap 120 is coupled. Also, the user may check the amount of liquid stored in the cartridge 40 even in a dark environment. Also, the aerosol-generating device 100 may provide various aesthetic effects depending on the color of the light emitted from the light source 61. Also, the user may check the state of the stick 80 or 80′ inserted into the insertion space 414.

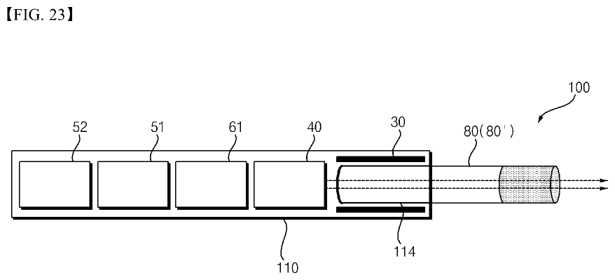

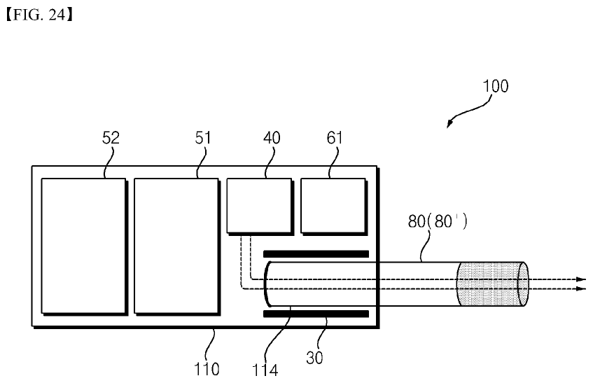

Referring to FIGS. 23 and 24, the aerosol-generating device 100 may include at least one of a battery 52, a controller 51, a heater 30, a cartridge 40, or a light source 61. At least one of the battery 52, the controller 51, the heater 30, the cartridge 40, or the light source 61 may be disposed inside the body 110 of the aerosol-generating device 100.

The body 110 may have formed therein an elongated hollow portion. The body 110 may have formed therein an insertion space 114 into which the stick 80 or 80′ is inserted. The insertion space 114, into which the stick 80 or 80′ is inserted, may be formed in the vicinity of the heater 30.

Referring to FIG. 23, the battery 52, the controller 51, the light source 61, the cartridge 40, and the heater 30 may be arranged in a row. Referring to FIG. 24, the cartridge 40 and the heater 30 may be disposed parallel to each other so as to face each other at a similar height. The internal structure of the aerosol-generating device 100 is not limited to that illustrated in the drawings.

The battery 52 may supply power required to operate at least one of the controller 51, the heater 30, the cartridge 40, or the light source 61. The battery 52 may supply power required to operate a display, a motor, etc. mounted in the aerosol-generating device 100. The battery 52 may be referred to as a power supply 52.

The controller 51 may control the overall operation of the aerosol-generating device 100. The controller 51 may control the operation of at least one of the battery 52, the heater 30, the cartridge 40, or the light source 61. The controller 51 may control the operation of the display, the motor, etc. mounted in the aerosol-generating device 100. The controller 51 may determine whether the aerosol-generating device 100 is in an operable state by checking the state of each of the components of the aerosol-generating device 100.

The heater 30 may generate heat using power supplied from the battery 52. The heater 30 may heat the stick 80 or 80′ inserted into the aerosol-generating device 100. The heater 30 may be referred to as a first heater 30.

The cartridge 40 may be coupled to one side of the body 110. The cartridge 40 may generate an aerosol. The aerosol generated in the cartridge 40 may pass through the stick 80 or 80′ inserted into the aerosol-generating device 100, and may then be delivered to the user. The cartridge 40 may be detachably coupled to the body 110.

The light source 61 may be disposed adjacent to the cartridge 40. The light source 61 may provide light to the cartridge 40. The light source 61 may be electrically connected to the controller 51 so as to operate.

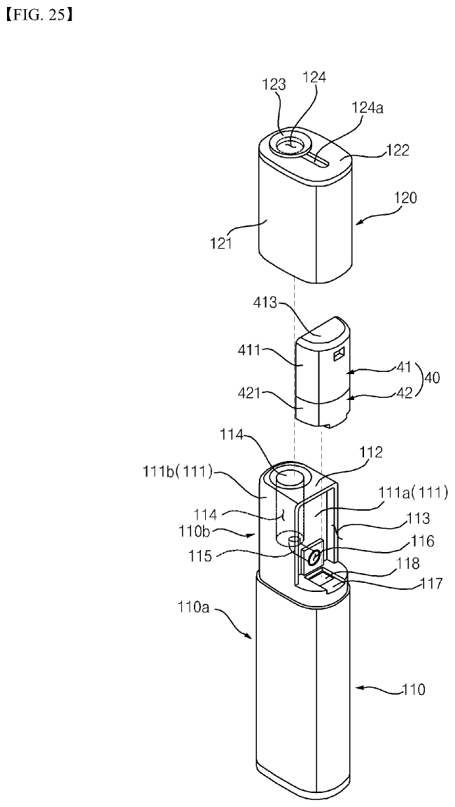

Referring to FIG. 25, the body 110 may include a lower body 110a and an upper body 110b disposed on the lower body 110a. The lower body 110a may accommodate at least one of the controller 51 or the battery 52 (refer to FIGS. 23 and 24). The upper body 110b may be elongated upwards from the upper portion of the lower body 110a. An insertion space 114 may be formed in the upper body 110b so as to be elongated in the upward-downward direction. The cartridge 40 may be disposed on the lower body 110b so as to face the upper body 110b. The upper body 110b may be disposed parallel to the cartridge 40 so as to face the cartridge 40. The upper body 110b may accommodate the light source 61. A mounting/demounting space 113, in which the cartridge 40 is disposed, may be located between the lower body 110a and the upper body 110b. A support surface 117 may face the lower portion of the mounting/demounting space 113. The cartridge 40 coupled to the body 110 may be electrically connected to the components located inside the body 110 through a terminal 118 disposed on the support surface 117.

The upper body 110b may provide an elongated hollow portion or an insertion space 114. The upper body 110b may provide an elongated insertion space 114. The insertion space 114 may have an open top to communicate with the outside. The insertion space 114 may communicate with an opening 124 in the cap 120.

The cap 120 may include a cover 123, which opens or closes the opening 124. The cover 123 may move along an extended portion 124a of the opening 124 to open or close the opening 124.

A first inlet 116 may be formed in the upper body 110b. The first inlet 116 may be formed in the first sidewall 111a of the upper body 110b. The first inlet 116 may communicate with the interior of the second container 42.

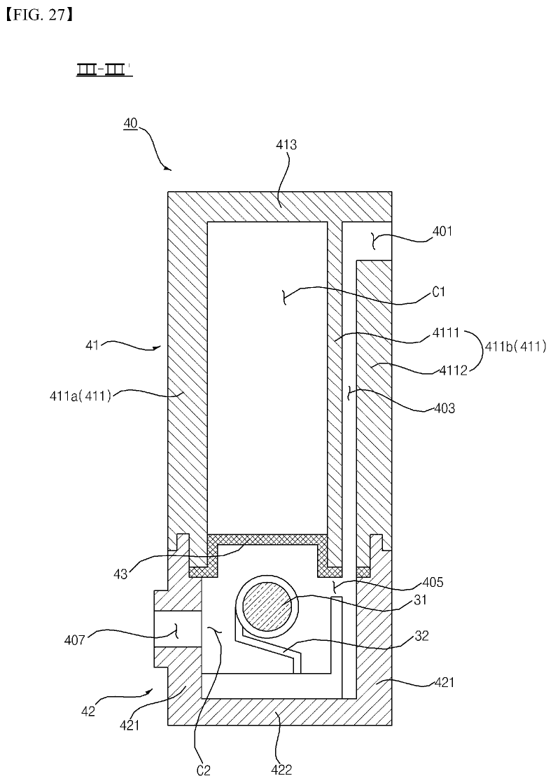

A connection passage 115 may be formed in the upper body 110b. The connection passage 115 may cause the hollow portion or the insertion space 114 formed in the upper body 110b to communicate with a second chamber C2 (refer to FIG. 27) in the second container 42. The connection passage 115 may be disposed between the first inlet 116 and the insertion space 114. The connection passage 115 may cause the first inlet 116 to communicate with the insertion space 114.

The first inlet 116 may be disposed at a position lower than the insertion space 114. The first inlet 116 and the insertion space 114 may communicate with each other. The first inlet 116 may be formed to be open in a direction intersecting the longitudinal direction of the insertion space 114. The first inlet 116 may be formed to be open in the forward direction.

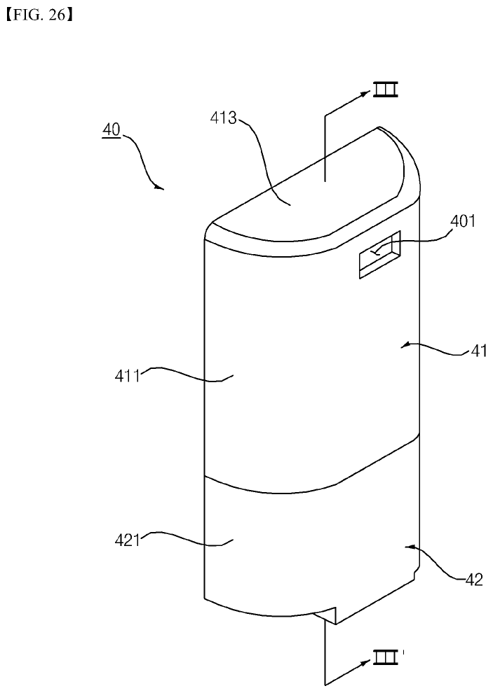

Referring to FIGS. 26 and 27, the cartridge 40 may include a first container 41 for storing a liquid and a second container 42 for generating an aerosol. The first container 41 and the second container 42 may be coupled to each other in the upward-downward direction. The first container 41 may be disposed on the second container 42. The liquid stored in the first container 41 may be supplied to the second container 42.

The first container 41 may have a second inlet 401 formed therein to receive external air introduced thereinto. The external air introduced into the second inlet 401 may pass through the second container 42.

The first container 41 may have a first chamber C1 formed therein to store a liquid. The first chamber C1 may be surrounded by the sidewall 411 and the upper wall 413 of the first container 41.

The sidewall 411 of the first container 41 may be connected to the upper wall 413 of the first container 41 to form the periphery of the first container 41. The sidewall 411 of the first container 41 may surround the side surface of the first chamber C1. The upper wall 413 of the first container 41 may cover the upper portion of the first chamber C1. The lower portion of the first container 41 may be open toward the second chamber C2.

The sidewall 411 of the first container 41 may include a first sidewall 411a and a second sidewall 411b. The first sidewall 411a of the first container 41 may face the first sidewall 111a of the upper body 110b (refer to FIG. 25). The first sidewall 411a of the first container 41 may face the interior of the aerosol-generating device 100. The first sidewall 411a of the first container 41 may be referred to as a first outer sidewall 411a.

The second sidewall 411b of the first container 41 may be disposed so as to face the first sidewall 411a of the first container 41. The second sidewall 411b of the first container 41 may face the outside of the aerosol-generating device 100. The second sidewall 411b of the first container 41 may not face the upper body 110b. The second sidewall 411b of the first container 41 may be referred to as a second outer sidewall 411b.

The cartridge 40 may have a second inlet 401 formed therein to receive external air introduced thereinto. A portion of the outer wall of the cartridge 40 may be open to form the second inlet 401. The second inlet 401 may be formed in the upper portion of the first container 41.

The first container 41 may have formed therein an inflow passage 403, which communicates with the second inlet 401 and extends downwards. The inflow passage 403 may connect the second inlet 401 to a chamber inlet 405.

The inflow passage 403 may be surrounded by passage walls 4111 and 4112. The passage walls 4111 and 4112 may be included in a portion of the second sidewall 411b of the first container 41. The passage walls 4111 and 4112 may be elongated in the upward-downward direction. The passage walls 4111 and 4112 may include an inner passage wall 4111 and an outer passage wall 4112.

The inner passage wall 4111 may be disposed inside the first container 41. The inner passage wall 4111 may extend downwards from the upper wall 413 of the first container 41 along the first chamber C1 and the inflow passage 403. The inner passage wall 4111 may be disposed between the first chamber C1 and the inflow passage 403. The first chamber C1 and the inflow passage 403 may be isolated from each other by the inner passage wall 4111. The first chamber C1 may be surrounded by the sidewall 411, the upper wall 413, and the inner passage wall 4111 of the first container 41.

The outer passage wall 4112 may form the outer wall of the first container 41. The outer passage wall 4112 may be disposed at a position further outward than the inner passage wall 4111. The outer passage wall 4112 may be contiguous with the second inlet 401. The outer passage wall 4112 may extend in the upward-downward direction along the inflow passage 403.

The second container 42 may be disposed beneath the first container 41. The second container 42 may have a second chamber C2 formed therein to communicate with the inflow passage 403. The second chamber C2 may be surrounded by the outer walls 421 and 422 of the second container 42. The sidewall 421 of the second container 42 may be connected to the lower wall 422 of the second container 42 to form the periphery of the second container 42. The sidewall 421 of the second container 42 may surround the side surface of the second chamber C2. The lower wall 422 of the second container 42 may cover the lower portion of the second chamber C2. The upper portion of the second container 42 may be open toward the first chamber C1.

The second container 42 may have formed therein a chamber inlet 405. The chamber inlet 405 may be connected to the inflow passage 403. The chamber inlet 405 may be connected to the second chamber C2. The chamber inlet 405 may be located between the inflow passage 403 and the second chamber C2. The chamber inlet 405 may connect the inflow passage 403 and the second chamber C2 to each other.

The second container 42 may have formed therein an outlet 407, which communicates with the second chamber C2 in order to discharge air. A portion of the sidewall 421 of the second container 42 may be open to form the outlet 407. The outlet 407 may be connected to the first inlet 116 formed in the upper case 110b (refer to FIG. 25). The aerosol generated in the second chamber C2 may be discharged through the outlet 407, and may then be delivered to the stick 80 or 80′ inserted into the aerosol-generating device 100 (refer to FIG. 24).

The wick 31 may be mounted in the second chamber C2. The wick 31 may receive a liquid from the first chamber C1.

The heater 32 may be disposed in the second chamber C2. The heater 32 may heat the wick 31. The heater 32 may be wound around the wick 31 multiple times. The heater 32 may heat the wick 31, to which the liquid is supplied, to generate an aerosol. The heater 30 disposed in the body 110 (refer to FIGS. 23 and 24) may be referred to as a first heater 30, and the heater 32 disposed in the second chamber C2 may be referred to as a second heater 32.

A plate 43 may be fixedly disposed between the first container 41 and the second container 42. The plate 43 may be disposed between the first chamber C1 and the second chamber C2. The plate 43 may have a flat shape. The plate 43 may partition the inner space in the cartridge 40 into the first chamber C1 and the second chamber C2 such that the first chamber C1 and the second chamber C2 are isolated from each other.

The plate 43 may have formed therein a liquid supply hole, through which the first chamber C1 and the second chamber C2 communicate with each other. The wick 31 may receive a liquid from the first chamber C1 through the liquid supply hole.

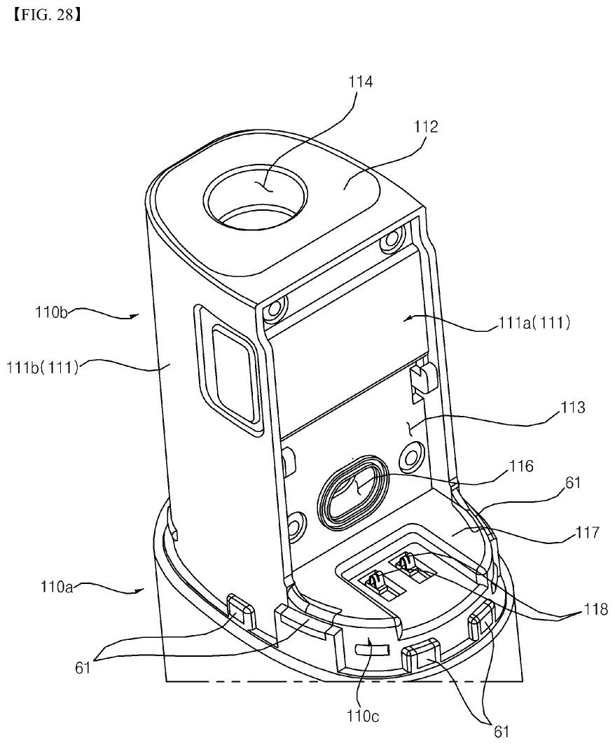

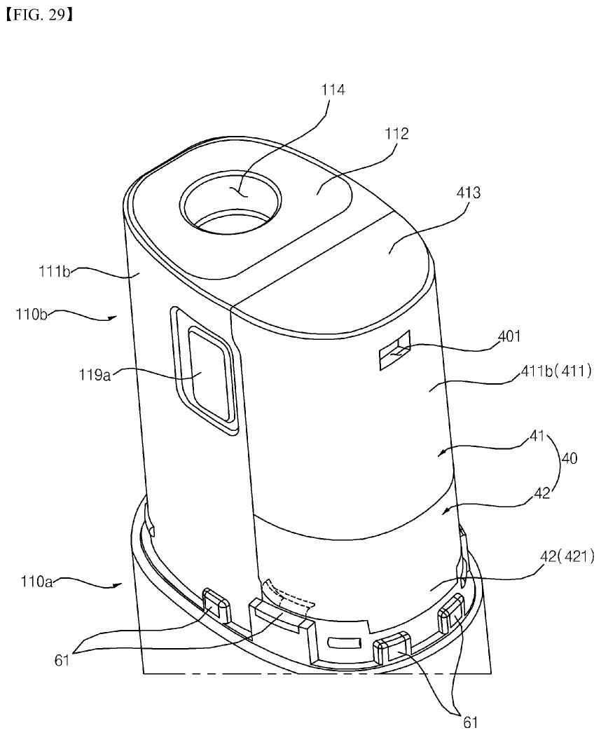

Referring to FIGS. 28 and 29, the light source 61 may be disposed adjacent to the second container 42. The light source 61 may face upwards. The light source 61 may face the first container 41. The light source 61 may provide light to the first container 41.

The light source 61 may be disposed adjacent to the lower periphery of the second container 42. At least a portion of the light source 61 may be disposed adjacent to the lower side of the sidewall 421 of the second container 42, and thus may overlap the sidewall 421 of the second container 42. The light source 61 may provide light to the second container 42. The second container 42 may include a window that transmits light. At least a portion of the light provided by the light source 61 may pass through the second container 42, and may be transmitted to the first container 41.

The light source 61 may be provided in a plural number. At least some of the plurality of light sources 61 may be arranged along the periphery of the second container 42.

Accordingly, the light emitted from the light sources 61 may be evenly provided to the periphery of the first container 41.

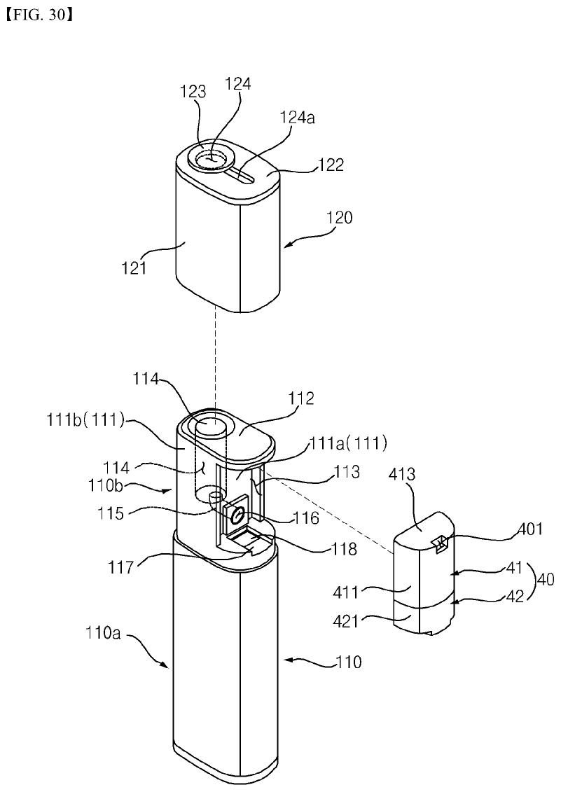

Referring to FIG. 30, the upper body 110b may include an extended portion 112a. The extended portion 112a may extend in the forward direction from the upper portion of the upper body 110b. The extended portion 112a may cover the upper side of the mounting/demounting space 113. The extended portion 112a may face the upper portion of the lower body 110a. The extended portion 112a may cover at least a portion of the upper portion of the cartridge 40.

The mounting/demounting space 113 may be defined by the sidewall 111, the extended portion 112a, and the support surface 117 of the upper body 110b. The mounting/demounting space 113 may be disposed parallel to the insertion space 114.

The cartridge 40 may move from the front to the rear to be inserted into the mounting/demounting space 113, and thus may be coupled to the body 110. The upper wall 413 of the first container 41 may be covered by the extended portion 112a.

The second inlet 401 may be open upwards in the upper end of the cartridge 40. The second inlet 401 may face an end portion of the extended portion 112a.

The cap 120 may be detachably coupled to the outer side of the upper body 110b. The sidewall 121 of the cap 120 may cover the sidewall 111 of the upper body 110b and the sidewalls 411 and 421 of the cartridge 40. The upper wall 122 of the cap 120 may cover the upper wall 112 of the upper body 110b.

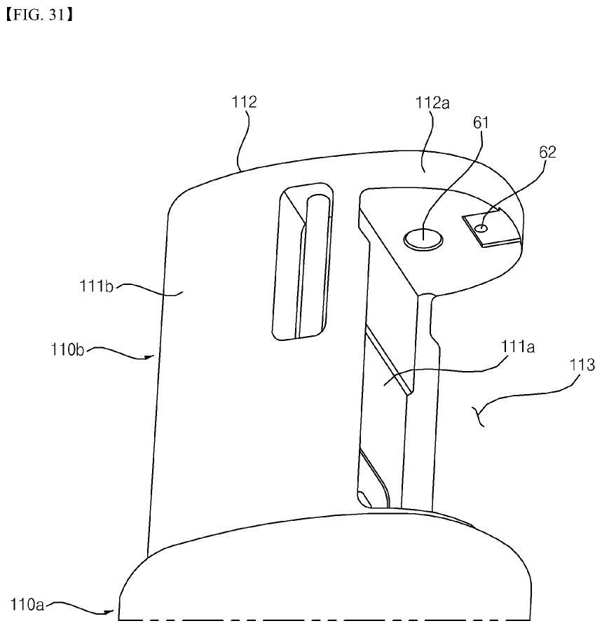

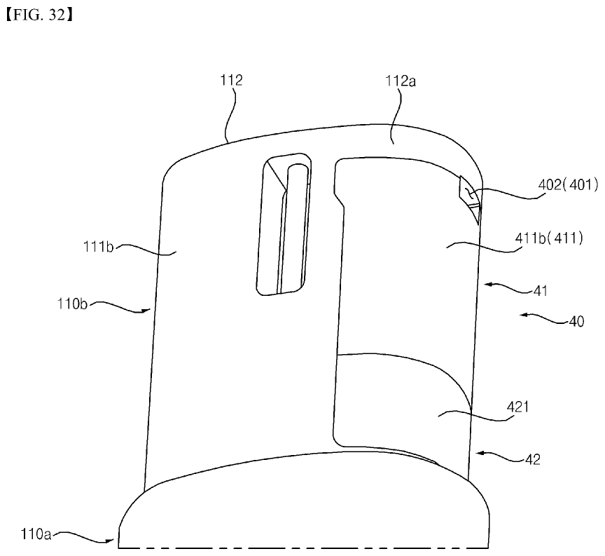

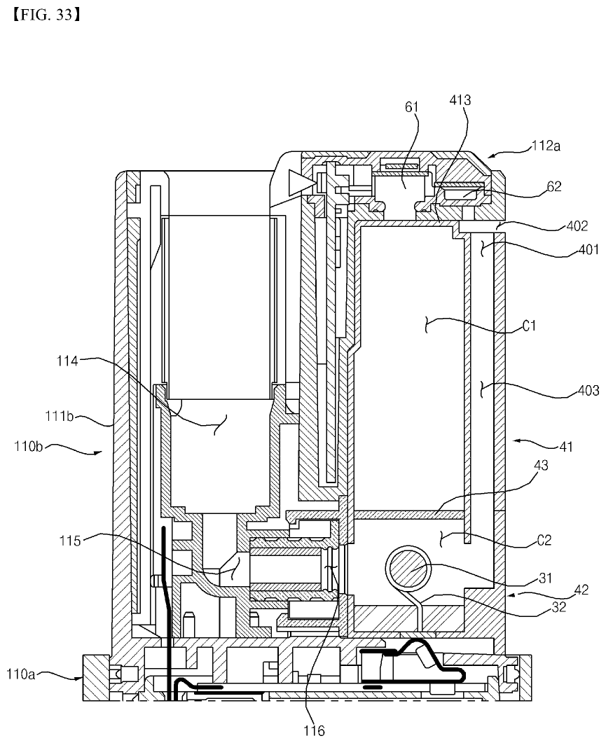

Referring to FIGS. 31 to 33, the extended portion 112a may face the upper wall 413 of the first container 41. The extended portion 112a may cover the upper wall 413 of the first container 41.

The light source 61 may be disposed adjacent to the upper side of the first container 41. The light source 61 may provide light to the first container 41. The light source 61 may face downwards. The light source 61 may face the first container 41. The light source 61 may be mounted in the extended portion 112a.

The second inlet 401 may face the lower portion of the extended portion 112a. A third inlet 402 may be formed between the end portion of the extended portion 112a and the second inlet 401. Air may be introduced into the third inlet 402 and the second inlet 401, and may then pass through the inlet passage 403. The sensor 62 may be mounted in the extended portion 112a. The sensor 62 may sense the flow of air. The sensor 62 may be a pressure sensor or an airflow sensor. The sensor 62 may be disposed adjacent to the second inlet 401 and the third inlet 402. The sensor 62 may sense the flow of air passing through the second inlet 401 and the third inlet 402.

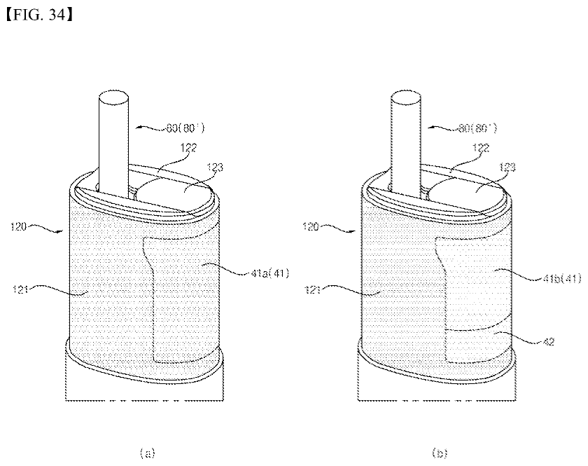

Referring to FIG. 34(a), when the light source 61 is not operating, light may not diffuse from the interior of the cap 120. The cartridge 40, which is disposed inside the cap 120, may be invisible or only faintly visible from outside the cap 120.

Referring to FIG. 34(b), when the light source 61 operates, the light source 61 may provide light to the cartridge 40. The light emitted from the light source 61 may sequentially pass through the cartridge 40 and the cap 120. The light that has passed through the cartridge 40 may diffuse from the interior of the cap 120 to the outside. The first container 41 may be visible from outside the cap 120.

Accordingly, the user may more clearly check the amount of liquid stored in the cartridge 40 with the naked eye in the state in which the cap 120 is coupled. Also, the user may check the amount of liquid stored in the cartridge 40 even in a dark environment. Also, the aerosol-generating device 100 may provide various aesthetic effects depending on the color of the light emitted from the light source 61.

Referring to FIGS. 1 to 34, an aerosol-generating device 100 in accordance with one aspect of the present disclosure may include a body 110, a cartridge 40, which is coupled to the body 110 wherein the cartridge 40 comprises: a first container 41 providing a storage space C1, a second container 42 adjacent to the first container 41, a wick 31 disposed in the second container 42 and be in communicated with the storage space C1, and a heater 32 for heating the wick 31, and a light source 61 disposed at the body 110 to be adjacent to the cartridge 40 to provide light to the cartridge 40. The first container 41 may include a window formed to allow the light provided by the light source 61 to pass therethrough.

In addition, in accordance with another aspect of the present disclosure, the light source 61 may be disposed to be directed toward the side surface of the first container 41.

In addition, in accordance with another aspect of the present disclosure, the body 110 may include a lower body 110a and an upper body 110b disposed above the lower body 110a and positioned to be adjacent to the cartridge 40, and the light source 61 may be disposed at the upper body 110b.

In addition, in accordance with another aspect of the present disclosure, the first container 41 may comprise an outer wall 411 and an inner wall 412, wherein the inner wall 412 defines an insertion space 414 in the first container 41, and the storage space C1 may be formed between the inner wall 412 and the outer wall 411.

In addition, in accordance with another aspect of the present disclosure, the light source 61 may face the first container 41, and may face the outside of the insertion space 414.

In addition, in accordance with another aspect of the present disclosure, the light source 61 may be one of a plurality of light sources 61, and the plurality of light sources 61 may be disposed opposite each other with respect to a position of the insertion space 414 and be oriented to face a same direction.

In addition, in accordance with another aspect of the present disclosure, the light source 61 may be disposed adjacent to the second container 42 and may be configured to face.

In addition, in accordance with another aspect of the present disclosure, the light source 61 may be one of a plurality of light sources 61, and at least some of the plurality of light sources 61 may be arranged along the periphery of the second container 42.

In addition, in accordance with another aspect of the present disclosure, the second container 42 may include the window.

In addition, in accordance with another aspect of the present disclosure, the light source 61 may be disposed to be adjacent to the upper side of the first container 41 and may face the first container 41.

In addition, in accordance with another aspect of the present disclosure, the body 110 may include a lower body 110a, and an upper body 110b disposed above the lower body 110a and positioned to be adjacent to the cartridge 40, wherein the upper body 110b comprises the insertion space 114 therein, wherein the upper body 110a comprises an extended portion 112a extending from the upper portion of the upper body 110b to cover at least a portion of the upper portion of the cartridge 40. The light source 61 may be mounted at the extended portion 112a.

In addition, in accordance with another aspect of the present disclosure, the aerosol-generating device may further include a cap 120 covering at least a portion of the body 110 and the cartridge 40. At least a portion of the cap 120 that covers the first container 41 may be configured to allow light provided by the light source 61 to pass the therethrough.

In addition, in accordance with another aspect of the present disclosure, the cap 120 may include a diffusion sheet 125 disposed along the periphery of the cap 120.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a body;
a cartridge coupled to the body, wherein the cartridge comprises: a first container providing a storage space, a second container adjacent to the first container, a wick disposed to be in communication with the storage space, and a heater configured to heat the wick; and
a light source disposed at the body so as to be adjacent to the cartridge and configured to provide light to the cartridge,
wherein the first container includes a window formed to allow light provided by the light source to pass therethrough.

2. The aerosol-generating device according to claim 1, wherein the light source is disposed to be directed toward a side surface of the first container.

3. The aerosol-generating device according to claim 2, wherein the body comprises:
a lower body; and
an upper body disposed above the lower body and positioned to be adjacent to the side surface of the cartridge, and
wherein the light source is disposed at the upper body.

4. The aerosol-generating device according to claim 1, wherein the first container comprises an outer wall and an inner wall, wherein the inner wall defines an insertion space in the first container, and
wherein the storage space is formed between the inner wall and the outer wall.

5. The aerosol-generating device according to claim 4, wherein the light source faces the first container, and faces an outside of the insertion space.

6. The aerosol-generating device according to claim 5, wherein the light source is one of a plurality of light sources, and
wherein the plurality of light sources are disposed opposite each other with respect to a position of the insertion space and are oriented to face a same direction.

7. The aerosol-generating device according to claim 1, wherein the light source is disposed adjacent to the second container and is configured to face upward.

8. The aerosol-generating device according to claim 7, wherein the light source is one of a plurality of light sources, and
wherein at least some of the plurality of light sources are arranged along a periphery of the second container.

9. The aerosol-generating device according to claim 7, wherein the second container includes the window.

10. The aerosol-generating device according to claim 1, wherein the light source is disposed to be adjacent to an upper side of the first container and face the first container.

11. The aerosol-generating device according to claim 10, wherein the body comprises:
a lower body; and
an upper body disposed above the lower body and positioned to be adjacent to the side surface of the cartridge, wherein the upper body comprises an insertion space therein,
wherein the upper body comprises an extended portion extending from an upper portion of the upper body to cover at least a portion of an upper portion of the cartridge, and
wherein the light source is mounted at the extended portion.

12. The aerosol-generating device according to claim 1, further comprising:
a cap covering at least a portion of the body and the cartridge,
wherein at least a portion of the cap that covers the first container is configured to allow light provided by the light source to pass therethrough.

13. The aerosol-generating device according to claim 12, wherein the cap includes a diffusion sheet disposed along a periphery of the cap.
